(19) United States
(12) Patent Application Publication
(10) Pub. No.: US 2026/0340011 A1
(43) Pub. Date: Oct. 29, 2026

(54) Methods for Data Access Retrieval Control and Inference Control of Artificial Intelligence (AI) Models

(71) Applicant: WitnessAI, Inc., Mountain View, CA (US)

(72) Inventors: Gil Spencer, Incline Village, NV (US); Amr A. Ali, Cairo (EG); Mathew Solnik, Dallas, TX (US)

(21) Appl. No.: 19/655,046

(22) Filed: Apr. 22, 2026

Related U.S. Application Data
(60) Provisional application No. 63/794,651, filed on Apr. 25, 2025.

(51) Int. Cl. G06F 16/334; G06F 16/35; G06F 21/62; G06F 40/30

(52) U.S. Cl. CPC G06F 16/3347; G06F 16/35; G06F 21/6209; G06F 40/30

(57) ABSTRACT

Methods and systems for tagging client data for role and intent-based access control in artificial intelligence models are described. In some implementations, client data items are tagged with access control metadata indicating an authorized user role and a permitted user intent. Vector representations are generated for the client data items using an embedding model based on the content and associated metadata, and these representations are stored in a searchable data repository. Upon receiving a query input, a user access context is determined based on the requesting user's role and intent. A metadata filter and query vector representation is generated from the access context to limit, before similarity scoring, the candidate set of vector representations to those compatible with the user access context. A restricted similarity search may retrieve policy-compatible client data items, and a restricted response may be generated using an artificial intelligence model, subject to inference constraints.

### CROSS REFERENCE TO RELATED APPLICATIONS

The present patent application claims the priority benefit of U.S. Provisional Patent Application Ser. No. 63/794,651, filed Apr. 25, 2025, assigned to the assignee hereof, and which is hereby incorporated by reference in its entirety.

### FIELD OF TECHNOLOGY

The present disclosure relates to Artificial Intelligence (AI) and, more particularly, to data access retrieval control and inference control of an Artificial Intelligence (AI) model using access control metadata and restricted similarity search.

### BACKGROUND

In the digital age, the use of Artificial Intelligence (AI) models (e.g., large language models (LLMs)) has become increasingly prevalent. These models, which are typically based on deep learning techniques, have the ability to process and generate human-like text, making them valuable tools in a variety of applications such as natural language processing, machine translation, and text generation. However, the widespread use of LLMs has also raised concerns about data privacy and security. LLMs are often trained on large amounts of data, some of which may be sensitive or confidential. Therefore, there is a need for systems and methods that can control access to LLMs and the data they process, ensuring that only authorized users can interact with the models and view the output. Artificial intelligence systems, including large language models (LLMs), are increasingly deployed to retrieve, analyze, and generate information from enterprise data sources. In many deployments, documents, records, messages, and other datasets are ingested into a retrieval-augmented generation (RAG) architecture in which source content is segmented into chunks, converted into embeddings, and stored in a vector database for similarity-based retrieval. A retrieved set of chunks can be supplied as context to an LLM at inference time to generate a response to a user query. Although such architectures can improve the relevance of model outputs, they can also introduce security and governance challenges when the underlying data includes content having different confidentiality, sensitivity, provenance, or permitted-use characteristics.

Role-based access control (RBAC) mechanisms are commonly used to control whether a user can access an application, database, application programming interface, or user interface. Existing RBAC mechanisms generally operate at the application level and determine whether a user can access a protected resource or perform a defined operation. Such mechanisms may be effective for controlling access to conventional system resources, but they do not provide fine-grained control over semantic content represented within an artificial intelligence knowledge base. In a RAG environment, semantically searchable content from multiple sources can be stored in a common vector database even when the underlying source materials are subject to materially different access restrictions. Once such content has been transformed into embeddings and indexed for similarity search, conventional RBAC does not provide a mechanism to express that a particular embedding corresponds to restricted data while another embedding corresponds to public or less restricted data.

This limitation can result in a lack of embedding-level access control. Vector databases typically store embeddings as numerical vectors and retrieve them according to semantic similarity to a query. Conventional RBAC can determine whether a user is permitted to query the vector database as a system resource, but ordinarily cannot determine, at the level of an individual embedding, whether a retrieved vector represents content the user is authorized to access. As a result, once a user is granted query access to the vector database, the retrieval pipeline can return embeddings derived from content outside the user's permitted scope.

Additional deficiencies arise at inference time. Even where retrieval restrictions are applied to a vector database, a standard LLM can generate restricted information from model parameters, including information learned during pre-training or fine-tuning, or from combinations of partially authorized context. Conventional RBAC does not provide a mechanism to evaluate or filter model outputs according to whether the generated content itself falls outside the user's authorization boundary. As a result, controlling access to an upstream data repository does not necessarily prevent disclosure of restricted information in an output generated by the LLM.

Conventional RBAC also lacks intent-awareness. Existing permission models generally assign static permissions to a user or role without considering the purpose for which information is requested. In artificial intelligence systems, however, the same user can require different levels of access depending on the nature of the query. For example, a user can be permitted to receive aggregate or analytical information for one task, while access to person-specific information for another task can be limited to data associated with direct reports, assigned cases, or another narrower scope. Conventional RBAC does not provide a mechanism to distinguish among such request contexts and, as a result, cannot reliably tailor access decisions to the user's intent at the time of inference.

Existing RBAC mechanisms also do not protect against inference attacks or cumulative information disclosure across multiple prompts. A user having partial access to a dataset can submit a sequence of individually authorized prompts that, when considered together, reveal information beyond the user's authorized scope. Such prompts can be structured to narrow candidate populations, correlate information across categories, or derive protected facts indirectly from multiple responses. Conventional RBAC evaluates access on a request-by-request basis and lacks a mechanism to account for cumulative disclosure, prompt sequencing, or progressive extraction of restricted information across a session.

Accordingly, existing access control approaches remain inadequate for artificial intelligence systems that retrieve and generate information based on semantic similarity and model inference. There remains a need for systems and methods that provide access control at the embedding level, apply authorization constraints during inference and output generation, account for the intent associated with a request, and reduce unauthorized disclosure arising from inference attacks or cumulative querying.

### SUMMARY

The described techniques relate to improved methods, systems, devices, and apparatuses that support techniques for tagging client data for role and intent-based access control in AI models. Some implementations may address these challenges by introducing a system that tags client data with access control metadata and integrates these tags into policy-conditioned vector embeddings. The access control metadata may include user roles, permitted intents, sensitivity classifications, and inference control flags, which may be applied at multiple stages of the data ingestion pipeline. These tags may be incorporated into the embedding process, ensuring that access restrictions are encoded into the geometric properties of the vector representations. The tagged and embedded data may be stored in a vector data repository, where the metadata fields may be indexed for efficient filtering.

When a user submits a query, the system may dynamically determine the user's access context, including their role and the intent associated with the query. A metadata filter may be generated to restrict the candidate set of vector representations to those compatible with the user's access context. A restricted similarity search may then be performed, ensuring that only authorized data is retrieved. Post-retrieval validation may enforce additional inference control constraints, such as aggregation-only requirements or cross-reference restrictions. The system may ensure that responses generated by the artificial intelligence model are policy-compliant, secure, and aligned with the user's authorized scope of access. This multi-layered approach may provide robust access retrieval and inference control, enabling secure interactions with artificial intelligence models.

A method for tagging client data for role and intent-based access control in AI models is described. The method may include receiving client data items. The method may include tagging the client data items with access control metadata for access retrieval control and inference control, where the access control metadata may indicate an authorized user role and a permitted user intent for each of the client data items. The method may include generating, using an embedding model, vector representations for the client data items based on the content of the client data items and the access control metadata associated with the client data items. The method may include storing the vector representations and the access control metadata in a searchable data repository. The method may include receiving a query input from a requesting user. The method may include determining, based on the query input and an access profile of the requesting user, a user access context comprising a role of the requesting user and an intent associated with the query input. The method may include generating, from the user access context, a metadata filter and a query vector representation. The method may include applying the metadata filter to limit, before similarity scoring, a candidate set of the vector representations to vector representations having access control metadata compatible with the user access context. The method may include executing a restricted similarity search in the searchable data repository using the query vector representation against the candidate set of the vector representations to retrieve policy-compatible client data items. The method may include generating, using the AI model and subject to an inference constraint associated with the policy-compatible client data items, a restricted response based on the policy-compatible client data items.

A system configured for data access retrieval control and inference control of an Artificial Intelligence (AI) model is described. The system may include a processor, memory coupled with the processor, and instructions stored in the memory and executable by the processor. The system may be configured to receive client data items and tag the client data items with access control metadata for access retrieval control and inference control, where the access control metadata may indicate an authorized user role and a permitted user intent for each of the client data items. The system may generate, using an embedding model, vector representations for the client data items based on the content of the client data items and the access control metadata associated with the client data items. The system may store the vector representations and the access control metadata in a searchable data repository. The system may receive a query input from a requesting user and determine, based on the query input and an access profile of the requesting user, a user access context that may include a role of the requesting user and an intent associated with the query input. The system may generate, from the user access context, a metadata filter and a query vector representation. The system may apply the metadata filter to limit, before similarity scoring, a candidate set of the vector representations to vector representations having access control metadata compatible with the user access context. The system may execute a restricted similarity search in the searchable data repository using the query vector representation against the candidate set of the vector representations to retrieve policy-compatible client data items. The system may generate, using the AI model and subject to an inference constraint associated with the policy-compatible client data items, a restricted response based on the policy-compatible client data items.

Another system for tagging client data for role and intent-based access control in AI models is described. The system may include means for receiving client data items. The system may include means for tagging the client data items with access control metadata for access retrieval control and inference control, the access control metadata indicating an authorized user role and a permitted user intent for each of the client data items. The system may include means for generating, using an embedding model, vector representations for the client data items based on the content of the client data items and the access control metadata associated with the client data items. The system may include means for storing the vector representations and the access control metadata in a searchable data repository. The system may include means for receiving a query input from a requesting user. The system may include means for determining, based on the query input and an access profile of the requesting user, a user access context comprising a role of the requesting user and an intent associated with the query input. The system may include means for generating, from the user access context, a metadata filter and a query vector representation. The system may include means for applying the metadata filter to limit, before similarity scoring, a candidate set of the vector representations to vector representations having access control metadata compatible with the user access context. The system may include means for executing a restricted similarity search in the searchable data repository using the query vector representation against the candidate set of the vector representations to retrieve policy-compatible client data items. The system may include means for generating, using the AI model and subject to an inference constraint associated with the policy-compatible client data items, a restricted response based on the policy-compatible client data items.

A non-transitory computer-readable medium storing code for tagging client data for role and intent-based access control in AI models is described. The code may include instructions executable by a processor to receive client data items. The code may include instructions executable by a processor to tag the client data items with access control metadata for access retrieval control and inference control, the access control metadata indicating an authorized user role and a permitted user intent for each of the client data items. The code may include instructions executable by a processor to generate, using an embedding model, vector representations for the client data items based on content of the client data items and the access control metadata associated with the client data items. The code may include instructions executable by a processor to store the vector representations and the access control metadata in a searchable data repository. The code may include instructions executable by a processor to receive a query input from a requesting user. The code may include instructions executable by a processor to determine, based on the query input and an access profile of the requesting user, a user access context comprising a role of the requesting user and an intent associated with the query input. The code may include instructions executable by a processor to generate, from the user access context, a metadata filter and a query vector representation. The code may include instructions executable by a processor to apply the metadata filter to limit, before similarity scoring, a candidate set of the vector representations to vector representations having access control metadata compatible with the user access context. The code may include instructions executable by a processor to execute a restricted similarity search in the searchable data repository using the query vector representation against the candidate set of the vector representations to retrieve policy-compatible client data items. The code may include instructions executable by a processor to generate, using the AI model and subject to an inference constraint associated with the policy-compatible client data items, a restricted response based on the policy-compatible client data items.

Some examples of the method, systems, and non-transitory computer-readable medium described herein may further include operations, features, means, or instructions for assigning, during the tagging, a sensitivity classification to the client data items. The sensitivity classification may be selected from a hierarchy including public, internal, confidential, and restricted, and may be stored as part of the access control metadata in the searchable data repository.

Some examples of the method, systems, and non-transitory computer-readable medium described herein may further include operations, features, means, or instructions for segmenting the client data items into chunks prior to generating the vector representations. Each chunk may inherit document-level access control metadata and may be further tagged with chunk-specific metadata based on content analysis of the chunk.

Some examples of the method, systems, and non-transitory computer-readable medium described herein may further include operations, features, means, or instructions for constructing a structured policy prefix from the access control metadata associated with the client data items. The structured policy prefix may be prepended to text of the client data items, and the policy-augmented text may be embedded to generate the vector representations.

Some examples of the method, systems, and non-transitory computer-readable medium described herein may further include operations, features, means, or instructions for validating, after storing the vector representations, that each stored vector representation includes a complete and consistent set of access control metadata. Any vector representation missing required metadata may be quarantined for administrative review.

Some examples of the method, systems, and non-transitory computer-readable medium described herein may further include operations, features, means, or instructions for applying an output filter to the restricted response generated by the AI model. The output filter may be configured to redact restricted content derived from parametric memory of the AI model that is not included in the retrieved policy-compatible client data items.

Some examples of the method, systems, and non-transitory computer-readable medium described herein may further include operations, features, means, or instructions for executing an automated classifier during receipt of the client data items to detect sensitive content and assign a sensitivity classification included in the access control metadata.

In some examples of the method, systems, and non-transitory computer-readable medium described herein, storing the vector representations and the access control metadata in the searchable data repository may comprise storing the access control metadata as filterable metadata fields alongside respective ones of the vector representations.

In some examples of the method, systems, and non-transitory computer-readable medium described herein, determining the user access context may comprise applying an intent classification model to the query input to identify the intent associated with the query input.

In some examples of the method, systems, and non-transitory computer-readable medium described herein, determining the intent associated with the query input may further comprise updating an output of the intent classification model based on prior prompts received during a session of the requesting user.

In some examples of the method, systems, and non-transitory computer-readable medium described herein, the user access context may comprise a plurality of roles associated with the requesting user, and the metadata filter may be configured to admit a vector representation when the access control metadata of the vector representation is compatible with any one of the plurality of roles.

In some examples of the method, systems, and non-transitory computer-readable medium described herein, the metadata filter may include a temporal validity condition requiring access control metadata of an admitted vector representation to indicate current validity at a time of the restricted similarity search.

In some examples of the method, systems, and non-transitory computer-readable medium described herein, executing the restricted similarity search may comprise performing an approximate neighbor search over the candidate set of the vector representations.

Some examples of the method, systems, and non-transitory computer-readable medium described herein may further include operations, features, means, or instructions for evaluating retrieved client data items against one or more inference control flags after executing the restricted similarity search. A retrieved client data item that violates the one or more inference control flags may be removed.

In some examples of the method, systems, and non-transitory computer-readable medium described herein, the one or more inference control flags may comprise an aggregation-only flag and a minimum k-anonymity threshold for an aggregate response.

In some examples of the method, systems, and non-transitory computer-readable medium described herein, the one or more inference control flags may comprise a cross-reference restriction that prevents combining a first retrieved client data item from a first sensitivity domain with a second retrieved client data item from a second sensitivity domain in the restricted response.

In some examples of the method, systems, and non-transitory computer-readable medium described herein, generating the restricted response may comprise selecting, from a plurality of Artificial Intelligence (AI) models, the Artificial Intelligence (AI) model based on an uppermost sensitivity classification among the policy-compatible client data items retrieved by the restricted similarity search.

In some examples of the method, systems, and non-transitory computer-readable medium described herein, the query input from the requesting user may be a prompt.

Some examples of the method, systems, and non-transitory computer-readable medium described herein may further include operations, features, means, or instructions for assigning data provenance metadata to the client data items during the tagging. The data provenance metadata may include a source identifier, a document identifier, and an ingestion timestamp.

In some examples of the method, systems, and non-transitory computer-readable medium described herein, the metadata filter may be further configured to exclude vector representations associated with client data items having expired temporal validity tags.

In some examples of the method, systems, and non-transitory computer-readable medium described herein, the restricted response may be generated by applying an inference constraint that limits the response to aggregate statistics derived from the policy-compatible client data items.

Some examples of the method, systems, and non-transitory computer-readable medium described herein may further include operations, features, means, or instructions for assigning intent-scope indicators to the client data items during the tagging. The intent-scope indicators may specify permitted intents for accessing the client data items.

In some examples of the method, systems, and non-transitory computer-readable medium described herein, the restricted similarity search may further comprise applying a differential similarity scoring mechanism to reduce the likelihood of retrieving vector representations near an authorization boundary.

Some examples of the method, systems, and non-transitory computer-readable medium described herein may further include operations, features, means, or instructions for assigning inference control flags to the client data items during the tagging. The inference control flags may specify whether the client data items may be directly cited in the restricted response.

In some examples of the method, systems, and non-transitory computer-readable medium described herein, the restricted response may be generated by applying an output filter that replaces restricted content with redaction markers based on the access control metadata of the retrieved client data items.

### BRIEF DESCRIPTION OF THE DRAWINGS

FIG. 1 illustrates an example of a system for data processing that supports tagging client data for role and intent-based access control in AI models in accordance with aspects of the present disclosure.

FIG. 2 illustrates a tagging pipeline flowchart that supports techniques for tagging client data for role and intent-based access control in AI models in accordance with various aspects of the present disclosure.

FIG. 3 illustrates a restricted search flowchart that supports techniques for tagging client data for role and intent-based access control in AI models in accordance with various aspects of the present disclosure.

FIG. 4 shows an intent-policy matrix which supports techniques for tagging client data for role and intent-based access control in AI models in accordance with various aspects of the present disclosure.

FIG. 5 shows a divergent response comparison which supports techniques for tagging client data for role and intent-based access control in AI models in accordance with various aspects of the present disclosure.

FIG. 6 illustrates an example of a process flow that supports tagging client data for role and intent-based access control in AI models in accordance with various aspects of the present disclosure.

FIG. 7 shows a block diagram of an apparatus that supports tagging client data for role and intent-based access control in AI models in accordance with various aspects of the present disclosure.

FIG. 8 shows a block diagram of a data tagging component that supports tagging client data for role and intent-based access control in AI models in accordance with various aspects of the present disclosure.

FIG. 9 shows a diagram of a system including a device that supports tagging client data for role and intent-based access control in AI models in accordance with various aspects of the present disclosure.

FIG. 10 shows a flowchart illustrating methods that support tagging client data for role and intent-based access control in AI models in accordance with various aspects of the present disclosure.

FIG. 11 shows another flowchart illustrating methods that support tagging client data for role and intent-based access control in AI models in accordance with various aspects of the present disclosure.

### DETAILED DESCRIPTION

The detailed description and the accompanying drawings are provided to illustrate examples relating to data access retrieval control and inference control of an Artificial Intelligence (AI) model and are not intended to be limiting. In some embodiments, the disclosed subject matter may be implemented in different forms and particular arrangements, sequences, structures, acts, or components described in connection with one example may be omitted, substituted, combined with features of another example, or otherwise rearranged unless they are incompatible with the disclosed subject matter. Certain features, elements, or operations may be optional and need not be present in all embodiments. Well-understood structures, components, materials, acts, and processing techniques may be omitted or described at a high level so as not to obscure the disclosure. Accordingly, the disclosure may encompass modifications, variations, and equivalents falling within the scope of the appended claims.

The present disclosure relates generally to Artificial Intelligence (AI) and, more particularly, to data access retrieval control and inference control of an Artificial Intelligence (AI) model using access control metadata and restricted similarity search. In some embodiments, client data items may be represented as vector representations generated using an embedding model and stored with access control metadata in a searchable data repository. A query input from a requesting user may be evaluated using an access profile to determine a user access context, and a metadata filter and a query vector representation may be generated so that a candidate set of the vector representations is limited, before similarity scoring, to vector representations having access control metadata compatible with the user access context. A restricted similarity search may retrieve policy-compatible client data items, and a restricted response may be generated using the Artificial Intelligence (AI) model subject to an inference constraint associated with the policy-compatible client data items.

In retrieval-augmented artificial intelligence environments, client data from multiple sources may be transformed into vector representations and stored in a common searchable repository to support similarity-based retrieval and response generation. Conventional access control approaches may govern whether a user can reach an application, interface, or database, but may not provide sufficiently granular control over individual vector representations derived from content having different roles, permitted uses, or sensitivity levels. As a result, once semantically searchable content is indexed in a shared vector space, a retrieval pipeline may return information outside an authorized scope, and a model may further disclose restricted information through generated output, including by relying on model memory, combining partially authorized content, or responding to a sequence of prompts that progressively narrows toward protected information. Static permission models may also be insufficient where the same user may be permitted to receive one type of response for an analytical purpose but a narrower or different response for another purpose.

To address these and other technical issues, the present disclosure describes systems and methods in which client data items, including chunked portions thereof, may be tagged with access control metadata used for both access retrieval control and inference control. The access control metadata may indicate, for example, one or more authorized user roles, one or more permitted user intents, a sensitivity classification, and one or more inference control constraints, and may be incorporated into a policy-conditioned embedding process so that access restrictions are represented both as filterable metadata and in the geometric properties of the resulting vector representations. When a query is received, a user access context may be determined from an access profile of the requesting user and an intent associated with the query, and the user access context may be used to generate a metadata filter and a query vector representation for a restricted similarity search. By limiting the candidate set before similarity scoring, validating retrieved items against applicable inference constraints, and filtering or redacting generated output according to policy-compatible data, the disclosed techniques may provide context-aware control over retrieval and model response generation while reducing unauthorized disclosure across retrieval, inference, and output stages.

As used herein, the term data access retrieval control refers to control applied to retrieval operations on stored data such that data made available for retrieval is restricted according to applicable access rules before or during retrieval.

As used herein, the term inference control refers to control applied to generation, use, or release of information by an Artificial Intelligence (AI) model such that information provided in an output is restricted according to applicable policy, authorization, or use constraints.

As used herein, the term Artificial Intelligence (AI) model refers to a computational model configured to process input information and generate an output, and may include a model used for retrieval-augmented generation, analysis, classification, or response generation.

As used herein, the term client data items refers to data units received for storage, tagging, embedding, retrieval, processing, or use by the disclosed system, and may include documents, records, messages, datasets, portions thereof, or other machine-processable content.

As used herein, the term access control metadata refers to metadata associated with a client data item or a vector representation that indicates one or more access-related conditions governing retrieval, processing, use, or output of corresponding content.

As used herein, the term authorized user role refers to a role identified in access control metadata as being permitted to access, retrieve, use, or otherwise process corresponding client data items.

As used herein, the term permitted user intent refers to an intent identified in access control metadata as being allowed for access to or use of corresponding client data items.

As used herein, the term embedding model refers to a model configured to transform text or other content, optionally together with associated metadata, into a vector representation in a mathematical space.

As used herein, the term vector representations refers to machine-processable numerical representations of content generated by an embedding model and usable for similarity-based comparison, indexing, retrieval, or ranking.

As used herein, the term searchable data repository refers to a repository configured to store vector representations and associated information in a manner that supports searching, filtering, retrieval, or ranking.

As used herein, the term access profile refers to information associated with a requesting user and usable to determine access permissions, constraints, or scope, including one or more roles, policies, permissions, session information, or related context.

As used herein, the term user access context refers to context determined for a requesting user in connection with a query input and usable to control retrieval or response generation, the context including at least a role of the requesting user and an intent associated with the query input.

As used herein, the term metadata filter refers to a filter derived from user access context or policy information and configured to admit or exclude data based on access control metadata.

As used herein, the term query vector representation refers to a vector representation generated from a query input, optionally together with policy or access-context information, for use in similarity-based retrieval.

As used herein, the term candidate set refers to a set of vector representations or corresponding data items selected for consideration in a retrieval operation before a later operation narrows, ranks, or otherwise evaluates that set.

As used herein, the term restricted similarity search refers to a similarity-based search performed subject to one or more access-related restrictions such that retrieval is limited to content compatible with applicable access control metadata or user access context.

As used herein, the term policy-compatible client data items refers to client data items determined to be compatible with one or more applicable policies, constraints, or access conditions for a particular retrieval or response operation.

As used herein, the term inference constraint refers to a constraint applicable to generation of a response by an Artificial Intelligence (AI) model and governing what information may be included, omitted, transformed, aggregated, redacted, or otherwise provided.

As used herein, the term restricted response refers to a response generated subject to one or more access restrictions, inference constraints, filtering rules, or policy conditions.

As used herein, the term sensitivity classification refers to a classification that indicates a relative sensitivity level of content for access control purposes.

As used herein, the term chunks refers to segments into which client data items are divided for storage, tagging, embedding, retrieval, or processing.

As used herein, the term chunk-specific metadata refers to metadata associated with a particular chunk and reflecting one or more properties, classifications, conditions, or access rules applicable to that chunk.

As used herein, the term structured policy prefix refers to a structured expression of access control metadata arranged for inclusion with content prior to generation of a vector representation.

As used herein, the term policy-augmented text refers to text that includes original content together with one or more policy-related elements, including a structured policy prefix.

As used herein, the term output filter refers to a filter applied to an output generated by an Artificial Intelligence (AI) model to enforce one or more restrictions on content included in the output.

As used herein, the term parametric memory refers to information that may be reflected in parameters of an Artificial Intelligence (AI) model and available for generation independently of currently retrieved client data items.

As used herein, the term automated classifier refers to a classifier configured to analyze content automatically and assign one or more classifications, detections, labels, or other outputs without requiring manual review for each item.

As used herein, the term filterable metadata fields refers to metadata fields stored in a manner that permits filtering operations to be performed on the basis of values in those metadata fields.

As used herein, the term intent classification model refers to a model configured to identify, predict, or classify an intent associated with a query input.

As used herein, the term temporal validity condition refers to a condition based on time and used to determine whether access to corresponding content is currently valid.

As used herein, the term approximate neighbor search refers to a search technique configured to identify vector representations that are approximately closest to a query vector representation in a vector space.

As used herein, the term inference control flags refers to one or more flags that specify restrictions or conditions applicable to use of client data items in response generation or other inference-related operations.

As used herein, the term aggregation-only flag refers to a flag indicating that corresponding information is restricted to use in an aggregated form rather than in an item-specific or directly identifying form.

As used herein, the term k-anonymity threshold refers to a threshold that specifies a minimum number of entries, items, or records required for a response or data subset to satisfy an anonymity-related condition.

As used herein, the term aggregate response refers to a response that presents combined, summarized, statistical, or non-item-specific information derived from multiple data items.

As used herein, the term cross-reference restriction refers to a restriction that limits whether information from different data items, sources, or domains may be combined, correlated, or jointly used in a response.

As used herein, the term sensitivity domain refers to a domain or category associated with a sensitivity-related rule, boundary, or grouping for access control purposes.

As used herein, the term data provenance metadata refers to metadata indicating origin-related information for corresponding data.

As used herein, the term source identifier refers to information that identifies a source from which corresponding data originated.

As used herein, the term document identifier refers to information that identifies a document associated with corresponding data or content.

As used herein, the term ingestion timestamp refers to time information indicating when corresponding data was received, ingested, or entered into the system.

As used herein, the term temporal validity tags refers to one or more tags indicating time-based conditions affecting whether corresponding content is valid for access or use.

As used herein, the term aggregate statistics refers to statistics generated from multiple data items and expressing combined measures rather than item-specific content.

As used herein, the term intent-scope indicators refers to indicators specifying one or more permitted intents associated with access to corresponding client data items.

As used herein, the term differential similarity scoring mechanism refers to a mechanism that scores or adjusts similarity in different ways under different policy or authorization conditions.

As used herein, the term authorization boundary refers to a boundary, threshold, or limit separating content, operations, or outputs that are authorized from content, operations, or outputs that are not authorized for a given access context.

As used herein, the term redaction markers refers to symbols, characters, strings, placeholders, or other indicators inserted into an output in place of restricted content.

Methods, systems, devices, and apparatuses that support techniques for tagging client data for role and intent-based access control in AI models are disclosed. In some examples, conventional role-based access control systems may be inadequate for managing access to semantically rich data used by artificial intelligence models. These systems may fail to provide fine-grained control over individual data segments, such as vector embeddings, which may represent sensitive or confidential information. Once a user gains access to a vector database, traditional mechanisms may not distinguish between authorized and unauthorized content at the embedding level. Furthermore, existing systems may not account for user intent, which may vary across queries, nor may they prevent inference attacks where users derive restricted information through cumulative or indirect queries. The lack of mechanisms to enforce access retrieval and inference control at a granular level may expose organizations to risks of data leakage, policy violations, and unauthorized disclosure of sensitive information.

In some implementations, a system may manage data access and control by associating client data with metadata that governs how the data may be accessed, processed, and used. This metadata may be applied at various stages of the data lifecycle, beginning with the ingestion process. When data is initially received, coarse-grained metadata may be assigned based on the data source, which may include organizational identifiers, sensitivity classifications, and information about the data's origin. Automated processes may analyze the data to detect sensitive content, such as personally identifiable information, financial records, or proprietary details, and may assign appropriate sensitivity classifications accordingly. The metadata may serve as a foundation for subsequent operations, ensuring that access control policies are consistently applied throughout the system.

The data may then be divided into smaller segments, often referred to as chunks, to facilitate more granular control. Each chunk may inherit metadata from the original dataset while also receiving additional metadata specific to its content. For instance, a chunk containing salary information may be tagged with a classification indicating that it pertains to compensation data, while another chunk may be labeled with metadata reflecting its relevance to compliance or regulatory requirements. Before the data is transformed into a mathematical representation, known as an embedding, the metadata may be incorporated into the data by prepending a structured prefix to the text of each chunk. This prefix may encode the metadata into the embedding, ensuring that access control information is embedded directly into the data's mathematical representation. Once the embeddings are generated, a validation process may confirm that all entries in the data repository include complete and consistent metadata, flagging any entries with missing or incomplete metadata for review and temporarily excluding them from use.

The metadata attached to each chunk may encompass a wide range of information to support robust access control. Structured identifiers may reference centrally defined policies, enabling administrators to update access rules without modifying individual data entries. Metadata may specify which user roles are authorized to access the data, using predefined lists of roles and permissions. Sensitivity classifications may define the confidentiality level of the data, with hierarchical levels such as public, internal, confidential, and restricted. Additionally, metadata may indicate the types of user intents permitted for accessing the data, such as analyzing trends, retrieving individual records, or conducting compliance reviews. Flags within the metadata may control how the data may be used during processing, such as whether it may be cited directly, combined with other data, or used solely for aggregate analysis. Information about the data's origin, including the source system, document identifier, and timestamp, may also be included, along with optional time-based conditions that define when the data may be accessed or expire.

The system may store the tagged and embedded data in a repository optimized for efficient searching and retrieval. Each chunk may be stored as a record that includes its mathematical representation, metadata fields, original text, and references to the source document and the chunk's position within that document. Certain metadata fields, such as authorized roles, permitted intents, sensitivity levels, and time-based conditions, may be indexed to enable efficient filtering during searches. When a user submits a query, the system may determine the user's access context by retrieving information about the user's roles and analyzing the query to identify the user's intent. This intent may be inferred using a combination of signals, including real-time query analysis, patterns in the user's previous interactions, and rules defined by administrators. In some cases, users may explicitly declare their intent, which may then be cross-validated against the system's analysis to ensure consistency and compliance.

The system may use a predefined matrix to map the user's roles and intent to specific access rules, which may define the scope of data the user is permitted to access and any constraints on its use. For example, the rules may specify that certain data may only be used for aggregate analysis, that individual records may not be combined with data from other sources, or that responses must meet a minimum threshold for anonymity. Before performing a search, the system may apply a filter to the data repository to exclude any data that the user may not be authorized to access. This filter may be based on the user's access context and may ensure that unauthorized data is not included in the search process. Additionally, the user's query may be modified to include metadata from their access context, ensuring that the mathematical representation of the query aligns with the authorized data in the repository. The system may then perform a search to identify data that may be both relevant to the query and compatible with the user's access context.

After the search is completed, the system may perform additional checks on the retrieved data to enforce any constraints defined in the access rules. For instance, the system may ensure that responses only include aggregate statistics when required, that data from different sensitivity levels is not combined, and that responses meet predefined anonymity thresholds. The system may also monitor for patterns that suggest attempts to infer restricted information, such as submitting a series of increasingly specific queries or combining information from multiple queries to deduce sensitive details. When generating a response, the system may apply several methods to ensure compliance with access rules. If the retrieved data is properly filtered, the response may naturally exclude unauthorized information. The system may redact restricted content, replace specific details with generalized information, or block responses entirely if the query violates access rules. In some cases, the system may include a notice in the response to inform the user that access restrictions may have limited the scope of the answer.

The system may also select the appropriate processing model for generating responses based on the sensitivity of the retrieved data, the user's roles, and the identified intent. For example, highly sensitive data may be processed using a private model hosted within the organization's infrastructure, while non-sensitive data may be processed using publicly available models. The metadata attached to the data may persist throughout its lifecycle, ensuring that access control rules are consistently applied during data ingestion, storage, retrieval, processing, and output generation. If responses are cached for future use, the metadata may be stored alongside the response to ensure that subsequent users are subject to the same access rules. Metadata may also govern export operations, preventing users from extracting data in ways that violate access rules. If the data is used to train models, the metadata may inform the training process, such as by excluding sensitive data or applying methods to prevent the model from memorizing restricted content.

The system may allow metadata to be updated after the data has been stored, providing flexibility in adapting to changing access control requirements. Updates to metadata fields, such as changes to authorized roles or sensitivity levels, may be applied directly to the data repository without modifying the mathematical representations. If a change affects the metadata that was incorporated into the mathematical representation, the affected data may be reprocessed to update its representation. Metadata may reference policies that are defined and updated centrally, allowing changes to be applied without modifying the stored metadata. The system may also include features to optimize performance and efficiency. By filtering the data repository before performing searches, the system may reduce the amount of data that needs to be processed, improving response times. The alignment of query representations with authorized data may enhance the accuracy of searches, while tailoring the data retrieved based on the user's intent may optimize the use of computational resources.

To ensure compliance with access rules, the system may enforce access control at multiple stages of the data lifecycle. These stages may include filtering the data repository before searches, aligning query representations with authorized data, validating retrieved data against access rules, and applying restrictions to the generated responses. The system may apply the most restrictive interpretation of access rules to minimize the risk of unauthorized access or misuse. By combining robust metadata management, centralized policy updates, and multi-stage access control, the system may provide a comprehensive framework for managing data access and ensuring compliance with organizational policies and regulatory requirements.

Aspects of the subject matter described in this disclosure can be implemented to realize one or more of the following potential advantages. The described techniques may be implemented to support dynamic and context-aware access control mechanisms that may adapt to user roles, intents, and data sensitivity levels in real time. By embedding access control metadata directly into the mathematical representations of data, the system may ensure that unauthorized data remains inaccessible throughout the retrieval and processing pipeline. The use of policy-conditioned embeddings may enhance the precision of similarity searches by aligning query representations with authorized data, which may reduce false positives and improve response relevance. The system may mitigate risks associated with inference attacks by monitoring query patterns and applying constraints that may prevent the progressive disclosure of sensitive information. The ability to update metadata and policies without reprocessing the entire dataset may provide flexibility in responding to evolving organizational requirements and regulatory changes. By enforcing access control at multiple stages, the system may reduce the likelihood of unauthorized access while maintaining efficient and accurate data retrieval and response generation.

Aspects of the disclosure are initially described in the context of networked computing systems. Aspects of the disclosure are additionally illustrated by and described with reference to example implementations. Aspects of the disclosure are further illustrated by and described with reference to apparatus diagrams, system diagrams, and flowcharts that relate to tagging client data for role and intent-based access control in AI models.

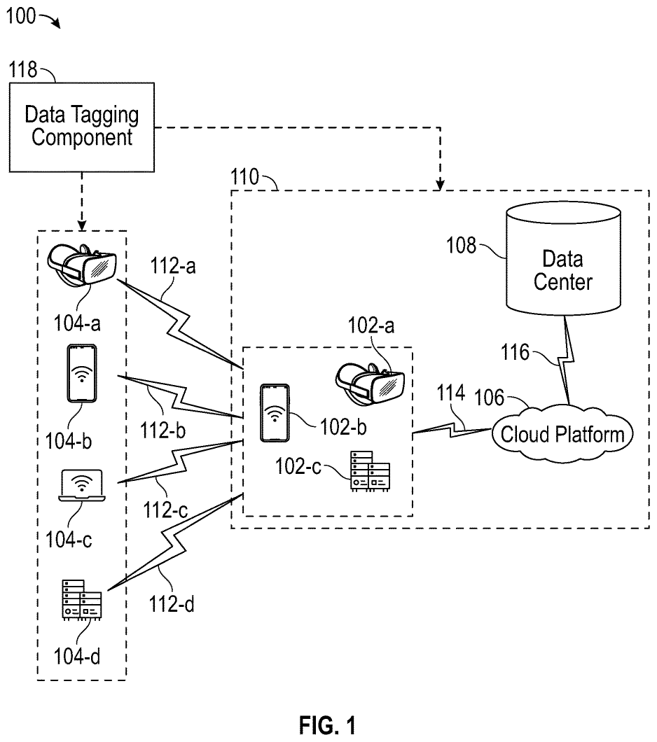

FIG. 1 illustrates an example of a system 100 that supports tagging client data for role and intent-based access control in AI models in accordance with various aspects of the present disclosure. The system 100 includes cloud clients 102, user devices 104, a cloud platform 106, and a data center 108. Cloud platform 106 may be an example of a public or private cloud network. A cloud client 102 may access cloud platform 106 over a network connection 114. The network connection 114 may include a wired connection, a wireless connection, or both. The network may implement transfer control protocol and internet protocol (TCP/IP), such as the Internet, or may implement other network protocols. A cloud client 102 may be an example of a computing device, such as a wearable device (e.g., cloud client 102-a), a smartphone (e.g., cloud client 102-b), or a server (e.g., cloud client 102-c). In other examples, a cloud client 102 may be a desktop or laptop computer, a tablet, a sensor, or another computing device or system capable of generating, analyzing, transmitting, or receiving communications. In some examples, a cloud client 102 may be part of a business, an enterprise, a non-profit, a startup, or any other organization type.

A cloud client 102 may facilitate communication between the data center 108 and one or multiple user devices 104 to implement an online environment. The network connection 112 may include communications, opportunities, purchases, sales, or any other interaction between a cloud client 102 and a user device 104. The network connection 112 may include a wired connection, a wireless connection, or both. A cloud client 102 may access cloud platform 106 to store, manage, and process the data communicated via one or more network connections 112. In some cases, the cloud client 102 may have an associated security or permission level. A cloud client 102 may have access to certain applications, data, and database information within cloud platform 106 based on the associated security or permission level, and may not have access to others.

The user device 104 may include a data tagging component 118. The user device 104 may interact with the cloud client 102 over network connection 112. The network may implement transfer control protocol and internet protocol (TCP/IP), such as the Internet, or may implement other network protocols. The network connection 112 may facilitate transport of data via email, web, text messages, mail, or any other appropriate form of electronic interaction (e.g., network connections 112-a, 112-b, 112-c, and 112-d) via a computer network. In an example, the user device 104 may be a computing device such as a wearable device 104-a, a smartphone 104-b, a laptop 104-c, or a server 104-d. In other cases, the user device 104 may be another computing system. In some cases, the user device 104 may be operated by a user or group of users. The user or group of users may be a customer, associated with a business, a manufacturer, or any other appropriate organization.

Cloud platform 106 may offer an on-demand database service to the cloud client 102. In some cases, cloud platform 106 may be an example of a multi-tenant database system. In this case, cloud platform 106 may serve multiple cloud clients 102 with a single instance of software. However, other types of systems may be implemented, including, but not limited to, client-server systems, mobile device systems, and mobile network systems. In some cases, cloud platform 106 may support an online application. This may include support for sales between buyers and sellers operating user devices 104, service, marketing of products posted by buyers, community interactions between buyers and sellers, analytics, such as user-interaction metrics, applications (e.g., computer vision and machine learning), and the Internet of Things (IoT). Cloud platform 106 may receive data associated with generation of an online environment from the cloud client 102 over network connection 114, and may store and analyze the data. In some cases, cloud platform 106 may receive data directly from a user device 104 and the cloud client 102. In some cases, the cloud client 102 may develop applications to run on cloud platform 106. Cloud platform 106 may be implemented using remote servers. In some cases, the remote servers may be located at one or more data centers 108.

Data center 108 may include multiple servers. The multiple servers may be used for data storage, management, and processing. Data center 108 may receive data from cloud platform 106 via connection 116, or directly from the cloud client 102 or via network connection 112 between a user device 104 and the cloud client 102. The connection 116 may include a wired connection, a wireless connection, or both. Data center 108 may utilize multiple redundancies for security purposes. In some cases, the data stored at data center 108 may be backed up by copies of the data at a different data center (not pictured).

Server system 110 may include cloud clients 102, a cloud platform 106, a data tagging component 118, and a data center 108 that may coordinate with cloud platform 106 and data center 108 to implement an online environment. In some cases, data processing may occur at any of the components of server system 110, or at a combination of these components. Thus, the data tagging component 118 may be included in the user device 104, server system 110, or in part or in whole in both. In some cases, servers may perform the data processing. The servers may be a cloud client 102 or located at data center 108.

Some or all of the functionality attributed to the data tagging component 118 may be embodied or performed by one or more user devices 104, one or more components of server system 110 (e.g., cloud clients 102, a cloud platform 106, and/or a data center 108), and/or other components of system 100. The data tagging component 118 may receive signals and inputs from user device 104 directly, via cloud clients 102, and/or via cloud platform 106 or data center 108.

As described herein, some implementations may utilize the data tagging component 118 to associate client data items with access control metadata that may specify authorized user roles and permitted user intents. The data tagging component 118 may generate vector representations for the client data items by incorporating both the content of the client data items and the associated access control metadata. These vector representations, along with the access control metadata, may be stored in a searchable data repository accessible via cloud platform 106 or data center 108. Upon receiving a query input from a user device 104, the data tagging component 118 may determine a user access context based on the requesting user's access profile and the intent associated with the query input. Using the user access context, the data tagging component 118 may generate a metadata filter to restrict the candidate set of vector representations to those compatible with the user access context before performing similarity scoring. The metadata filter may be applied in conjunction with a query vector representation to execute a restricted similarity search, retrieving client data items that comply with access control policies. The retrieved client data items may then be used to generate a restricted response subject to inference constraints, ensuring policy-compliant interactions with AI models.

In some embodiments, an inference constraint is a rule, condition, or limitation that governs how one or more retrieved client data items may be used during artificial intelligence processing to generate a response. The inference constraint can restrict whether retrieved client data items may be combined, correlated, summarized, generalized, or used to derive person-specific, record-specific, or otherwise sensitive conclusions. In some embodiments, an inference constraint can require aggregation, enforce a minimum k-anonymity threshold, prevent cross-domain correlation, limit response granularity, or block generation of a response when a requested inference exceeds an authorized scope.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

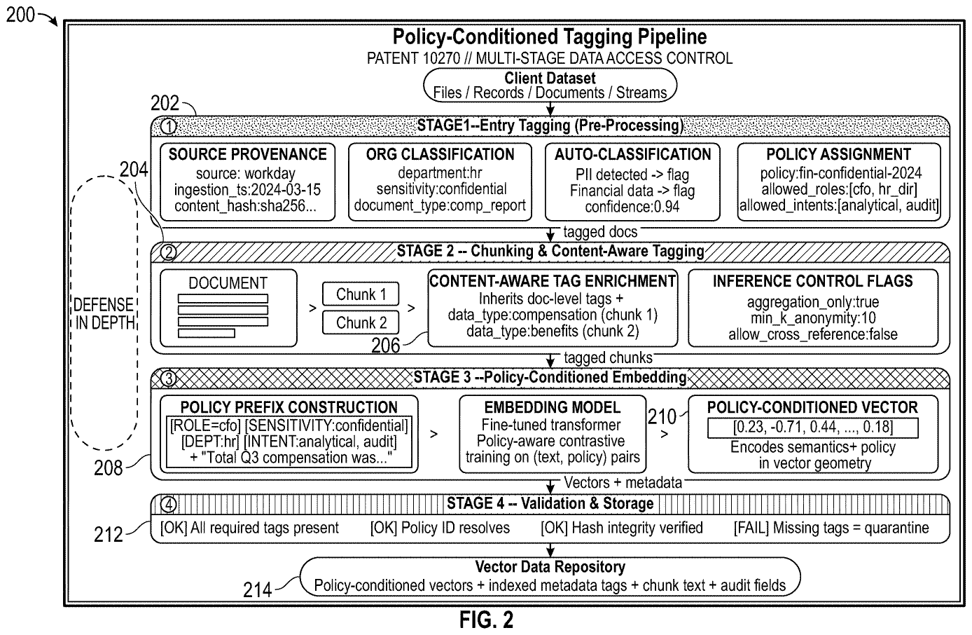

FIG. 2 illustrates a policy-conditioned tagging flowchart 200 that supports techniques for tagging client data for role and intent-based access control in AI models in accordance with various aspects of the present disclosure. Operations illustrated in the policy-conditioned tagging flowchart 200 may involve the cloud platform 106 and/or other participants, which may be examples of corresponding aspects described herein. The policy-conditioned tagging flowchart 200 may describe a process for tagging, segmenting, enriching, embedding, storing, and validating client data to enable policy-conditioned access control. In the illustrated embodiment, the policy-conditioned tagging flowchart 200 is arranged as a multi-stage process that begins with a client dataset and proceeds through a stage 1—entry tagging (pre-processing), a stage 2—chunking and content-aware tagging, a stage 3—policy-conditioned embedding, and a stage 4—validation and storage before committing output to a vector data repository. As shown, the policy-conditioned tagging flowchart 200 may be implemented by the cloud platform 106 and may operate on client dataset files, records, documents, or streams to support data access retrieval control and inference control of an Artificial Intelligence (AI) model.

The first stage 1 may receive the client dataset and may tag the client data items with access control metadata. In the illustrated embodiment, the first stage 1 includes source provenance, org classification, auto-classification, and policy assessment. The source provenance at the first stage 1 may include data provenance metadata, such as a source identifier, a document identifier, and an ingestion timestamp, for the client data items. The org classification at the first stage 1 may assign organizational or sensitivity classification information to the client data items. The auto-classification at the first stage 1 may execute an automated classifier to detect sensitive content and assign a sensitivity classification included in the access control metadata. The policy assessment at the first stage 1 may assign an authorized user role, a permitted user intent, temporal validity conditions, or one or more inference control flags for respective ones of the client data items.

At 202, the cloud platform 106 may tag the client dataset with metadata that may include access control information. In some implementations, the metadata may specify roles authorized to access the data, such as “finance_analyst” or “hr_manager.” The metadata may include sensitivity classifications, such as “confidential” or “restricted,” to indicate the level of data protection required. The metadata may further include intent indicators, such as “analytical_aggregate” or “personal_data_lookup,” to define permissible use cases for the data. In some implementations, the metadata may incorporate temporal validity tags, such as “valid_after: 2024-01-01,” to restrict access based on time constraints.

The second stage 2 may segment the client data items into chunks prior to generating the vector representations. As shown, the second stage 2 includes a document, a chunk 1, a chunk 2, content-aware tag enrichment 206, and inference control flags. The document at the second stage 2 may represent an ingested client data item, and the chunk 1 and the chunk 2 may represent segmented portions of the ingested client data item. In some embodiments, each chunk inherits document-level access control metadata and is further tagged with chunk-specific metadata based on content analysis of the chunk. The content-aware tag enrichment at the second stage 2 may add content-specific attributes to the access control metadata, including data-type tags, provenance metadata, or cryptographic hashes. The inference control flags at the second stage 2 may specify whether a corresponding chunk may be directly cited in a restricted response, whether use is limited to aggregation, or whether cross-reference restrictions are to be enforced.

At 204, the cloud platform 106 may segment the client dataset into chunks that may represent smaller, manageable portions of the data. In some implementations, the segmentation may involve dividing documents into fixed-size chunks, such as 500-character blocks, to facilitate processing. The segmentation may consider semantic boundaries, such as paragraphs or sections, to preserve contextual integrity within each chunk. The segmentation may include structural elements, such as tables or bullet points, to ensure that meaningful data units are retained. In some implementations, the segmentation process may generate a unique identifier for each chunk to maintain traceability to the original document.

At the content-aware tag enrichment 206, the cloud platform 106 may enrich the chunk-level tags with additional metadata that may include content-specific attributes. In some implementations, the enrichment may involve analyzing the chunk's content to assign data-type tags, such as “compensation” or “medical.” The enrichment may include provenance metadata, such as the source system identifier “workday” or “salesforce,” to track the origin of the data. The enrichment may add cryptographic hashes, such as SHA-256, to verify the integrity of the chunk's content. In some implementations, the enrichment may incorporate automated classifiers to detect sensitive information, such as personally identifiable information (PII) or trade secrets.

The third stage 3 may generate vector representations for the client data items based on content of the client data items and the access control metadata associated with the client data items. In the illustrated embodiment, the third stage 3 includes policy prefix construction, an embedding model, and a policy-conditioned vector. The policy prefix construction at the third stage 3 may construct a structured policy prefix from the access control metadata associated with the client data items. In some embodiments, the structured policy prefix is prepended to text of the client data items as policy-augmented text. The embedding model at the third stage 3 may generate the vector representations from the policy-augmented text such that the resulting policy-conditioned vector encodes both semantic content and policy information. In some embodiments, the embedding model is configured such that client data items having compatible access control metadata are represented in policy-coherent neighborhoods within a vector space.

At 208, the cloud platform 106 may construct a policy prefix that may represent access control metadata for embedding. In some implementations, the policy prefix may concatenate metadata fields, such as “[ROLE: finance_analyst][SENSITIVITY: confidential] [INTENT: analytical_aggregate].” The policy prefix may include hierarchical sensitivity levels, such as “public<internal<confidential<restricted,” to encode access restrictions. The policy prefix may be structured to include temporal conditions, such as “valid_until: 2025-12-31,” to enforce time-based access rules. In some implementations, the policy prefix may be designed to influence the embedding model's output by encoding access control constraints directly into the input text.

At 210, the cloud platform 106 may embed the chunks with a policy-conditioned embedding model that may encode access restrictions into the vector representations. In some implementations, the embedding model may be a fine-tuned transformer encoder trained to separate vectors based on policy compatibility. The embedding process may position vectors with similar semantic content but different policy prefixes in distinct subregions of the vector space. The embedding model may generate vectors that cluster together when they share identical policy prefixes, forming policy-coherent neighborhoods. In some implementations, the embedding process may ensure that query vectors aligned with a user's access context are geometrically closer to authorized chunks.

The fourth stage 4 may validate and store the vector representations and the access control metadata. As shown, the fourth stage 4 includes validation and storage, and the validated output may be committed to a vector data repository. In some embodiments, the validation performed at the fourth stage 4 confirms that each stored vector representation includes a complete and consistent set of access control metadata and quarantines any vector representation missing required metadata for administrative review. The vector data repository may store the vector representations and the access control metadata as searchable and filterable metadata fields alongside respective ones of the vector representations.

At 212, the cloud platform 106 may validate the metadata and quarantine any chunks that may be missing required tags. In some implementations, the validation process may check for the presence of critical metadata fields, such as “allowed_roles” or “sensitivity.” The validation may flag chunks with incomplete or inconsistent metadata for administrative review to prevent unauthorized access. The validation process may include automated integrity checks, such as verifying cryptographic hashes, to ensure data authenticity. In some implementations, quarantined chunks may be excluded from the searchable index until the metadata issues are resolved.

At 214, the cloud platform 106 may store the vector representations and metadata in a vector data repository that may include searchable fields. In some implementations, the repository may store the vector embeddings as high-dimensional float arrays alongside their corresponding metadata. The metadata fields may be indexed to enable efficient pre-filtering during similarity searches, such as filtering by “allowed_roles” or “sensitivity.” The repository may include the original chunk text to support retrieval and inclusion in AI model prompts. In some implementations, the repository may maintain document identifiers and chunk indices to facilitate context reconstruction during retrieval.

Accordingly, the policy-conditioned tagging flowchart 200 may provide policy-conditioned vectors and associated metadata tags that support downstream restricted similarity search, access retrieval control, and inference control for an Artificial Intelligence model.

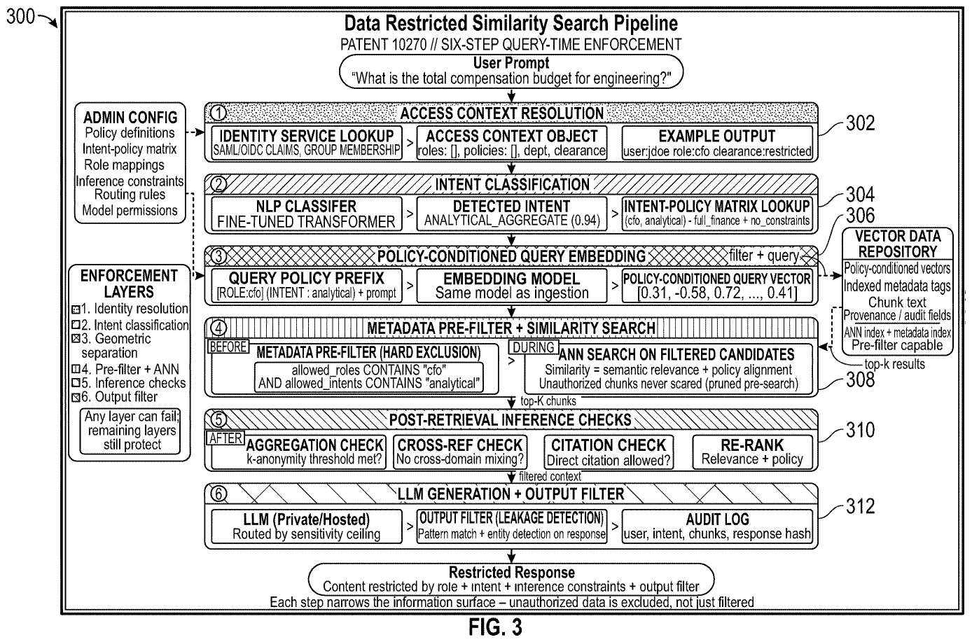

FIG. 3 illustrates a restricted search flowchart 300 that supports techniques for tagging client data for role and intent-based access control in AI models in accordance with various aspects of the present disclosure. Operations illustrated in the restricted search flowchart 300 may involve a user device, a cloud platform, and/or other participants, which may be examples of corresponding aspects described herein. The restricted search flowchart 300 may describe a process for resolving access context, classifying intent, generating policy-conditioned query embeddings, executing metadata pre-filters and similarity searches, performing post-retrieval inference checks, and generating filtered outputs to ensure secure and context-aware data retrieval. As shown, the restricted search flowchart 300 may be situated in an environment including a user device 104 and a cloud platform 106, and may support secure and context-aware retrieval of policy-compatible client data items using access control metadata, a metadata filter, a query vector representation, and an inference constraint.

At 302, the cloud platform 106 may determine the access context based on the user's role and associated policies. In some implementations, the cloud platform 106 may retrieve the user's role from an enterprise identity service, such as SAML or OIDC claims. The cloud platform 106 may reference an administration configuration to identify applicable access control policies for the user's role. The access context may include details such as the user's department, clearance level, and associated policies. The cloud platform 106 may store the resolved access context in a structured object for subsequent operations. In the illustrated embodiment, the access context resolution may receive the query input and may determine, based on the query input and an access profile of the requesting user, a user access context comprising a role of the requesting user and an intent associated with the query input. The access context resolution may retrieve the role from an enterprise identity service and may reference an administration configuration to identify applicable access control policies. In some implementations, the user access context may include department information, clearance level information, and associated policies, and may be stored in a structured object for subsequent operations in the restricted search flowchart 300.

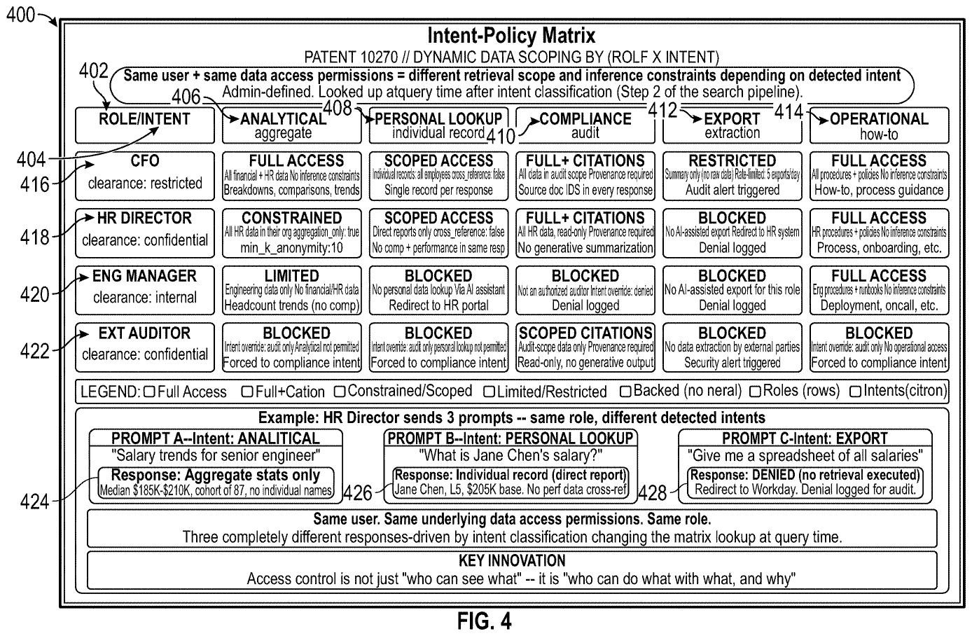

At 304, the cloud platform 106 may classify the intent of the query input to identify the user's purpose. In some implementations, the cloud platform 106 may apply an intent classification model to the query input to determine a probability distribution over predefined intent categories. The cloud platform 106 may select the intent category with the highest probability if it exceeds a confidence threshold. The cloud platform 106 may default to a restrictive intent category if the classification is ambiguous or uncertain. The cloud platform 106 may log the resolved intent for audit purposes. The intent classification may be arranged downstream of the access context resolution and may classify the intent associated with the query input to identify a purpose of the requesting user. In some implementations, the intent classification may apply an intent classification model to the query input to determine a probability distribution over predefined intent categories. The intent classification may select an intent category having a relatively higher probability when a confidence threshold is satisfied and may default to a restrictive intent category when classification is ambiguous or uncertain. The resolved intent may be logged for audit purposes. The intent classification may use the intent-policy matrix 400 shown in more detail in FIG. 4.

At 306, the cloud platform 106 may generate a policy-conditioned query embedding that incorporates access control metadata. In some implementations, the cloud platform 106 may construct a structured policy prefix from the user's access context and resolved intent. The cloud platform 106 may prepend the policy prefix to the query input text before passing it to an embedding model. The embedding model may generate a vector representation that encodes both the semantic content of the query and the access control metadata. The cloud platform 106 may store the policy-conditioned query embedding for use in subsequent similarity searches. The embedding model may receive the user access context and the resolved intent and may generate a query vector representation that is policy-conditioned. In some implementations, the embedding model may construct a structured policy prefix from the user access context and the resolved intent, prepend the structured policy prefix to text of the query input, and generate a vector representation encoding semantic content together with access control metadata. The query vector representation generated by the embedding model may be used in subsequent similarity searches and may geometrically separate authorized and unauthorized content in a vector space.

At 308, the cloud platform 106 may execute a metadata pre-filter and perform a similarity search to retrieve policy-compatible data. In some implementations, the cloud platform 106 may construct a metadata filter expression based on the user's access context and resolved intent. The metadata filter may limit the candidate set of vector representations to those with compatible access control metadata. The cloud platform 106 may perform an approximate nearest neighbor search using the policy-conditioned query embedding against the filtered candidate set. The cloud platform 106 may rank the retrieved data items by similarity score. The vector data repository may store vector representations and the access control metadata in a searchable data repository. In the restricted search flowchart 300, the vector data repository may cooperate with a metadata filter generated from the user access context to limit, before similarity scoring, a candidate set of the vector representations to vector representations having access control metadata compatible with the user access context. In some implementations, the vector data repository may store filterable metadata fields alongside respective ones of the vector representations, and the metadata filter may exclude vector representations associated with incompatible roles, incompatible permitted user intent, or expired temporal validity tags.

The ANN search may execute a restricted similarity search in the searchable data repository using the query vector representation against the candidate set of the vector representations to retrieve policy-compatible client data items. In some implementations, the ANN search may perform an approximate neighbor search and may rank retrieved client data items by similarity score. The ANN search may further support post-retrieval inference control by evaluating retrieved client data items against one or more inference control flags and removing a retrieved client data item that violates the one or more inference control flags. For example, the one or more inference control flags may comprise an aggregation-only flag, a minimum k-anonymity threshold for an aggregate response, or a cross-reference restriction.

At 310, the cloud platform 106 may perform post-retrieval inference checks to evaluate retrieved data against applicable constraints. In some implementations, the cloud platform 106 may verify whether retrieved data items comply with inference control flags, such as aggregation-only or cross-reference restrictions. The cloud platform 106 may remove data items that violate the specified constraints from the result set. The cloud platform 106 may re-rank the remaining data items based on relevance and policy compatibility. The cloud platform 106 may log the results of the inference checks for audit purposes.

At 312, the cloud platform 106 may generate an LLM output and apply an output filter to restrict unauthorized content. In some implementations, the cloud platform 106 may assemble the retrieved data items into a context for the LLM. The cloud platform 106 may instruct the LLM to generate a response that adheres to the specified inference constraints. The cloud platform 106 may apply an output filter to redact restricted content or enforce aggregation requirements in the generated response. The cloud platform 106 may return the filtered response to the user while logging the output for compliance tracking. The audit log may be arranged to receive outputs of the restricted similarity search and associated enforcement results. In some implementations, the audit log may log the resolved intent, results of inference checks, and generation of the restricted response for compliance tracking. The audit log may support review of how access retrieval control and inference control were applied to a given query input.

As further illustrated in FIG. 3, the restricted search flowchart 300 may include enforcement operations that combine metadata pre-filtering, policy-conditioned embedding, approximate neighbor search, post-retrieval inference checks, and output filtering. In some implementations, a Large Language Model (LLM) may generate the restricted response from the policy-compatible client data items, and an output filter may redact restricted content or enforce aggregation requirements before the restricted response is returned. Accordingly, FIG. 3 illustrates a particular embodiment in which access retrieval control and inference control are applied in sequence to narrow an information surface and restrict unauthorized content from being included in the restricted response.

FIG. 4 illustrates an example intent-policy matrix 400 for applying access control decisions based on both user role and detected user intent. As shown, the intent-policy matrix 400 is arranged as a table in which a first dimension corresponds to role 402 and a second dimension corresponds to intent 404. In the illustrated example, the intent categories include an analytical intent 406, a personal lookup intent 408, a compliance intent 410, an export intent 412, and an operational intent 414. The role categories include a chief financial officer (CFO) role 416, a human resources (HR) director role 418, an engineering manager role 420, and an external auditor role 422. Each intersection between one of the roles and one of the intents corresponds to a policy outcome that defines how a request associated with that role-intent combination is to be handled. The role 402 and the intent 404 are jointly evaluated within an enterprise access-control environment to govern whether a requesting user receives a restricted response having full access, scoped access, constrained access, or denied access, according to various embodiments of the present technology.

In some embodiments, the policy outcomes represented in the intent-policy matrix 400 include a full access response, a constrained aggregate response 424, a scoped access response 426, and a denied response 428. The full access response can indicate that the requesting user is permitted to receive a response with relatively broad access to the underlying data, subject to any applicable system safeguards. The scoped access response 426 can indicate that the requesting user is permitted to receive a limited or scoped response, such as an aggregated response, a redacted response, a response limited to an authorized subset of records, or a response requiring additional filtering or citation controls. The denied response 428 can indicate that the request is to be blocked or that no substantive response is to be generated for the detected role-intent combination.

In some embodiments, FIG. 4 demonstrates that different intents can lead to different access outcomes for the same role. For example, a given role may be associated with a constrained aggregate response 424 for an analytical intent 406, a scoped access response 426 for a personal lookup intent 408, and a denied response 428 for an export intent 412. Likewise, different roles may be associated with different outcomes for the same detected intent. Thus, the intent-policy matrix 400 enables the system to account for both who is making the request and why the request is being made, rather than relying solely on static role permissions.

In some embodiments, the intent-policy matrix 400 is used by a policy enforcement component after an intent associated with a query input has been detected or otherwise determined. The system can identify a role associated with the requesting user, determine the applicable intent category for the query input, locate a corresponding entry in the intent-policy matrix 400, and then apply one or more policy actions associated with that entry. The one or more policy actions can include generating metadata filters for restricted similarity search, applying inference control rules, selecting a model authorized for the sensitivity level implicated by the request, requiring aggregation or redaction, restricting cross-domain correlation, or denying the request.

FIG. 4 also illustrates, in some embodiments, that repeated prompts submitted by the same user can result in different access outcomes depending on detected intent. For example, the same user associated with the HR director role 418 can submit a first prompt categorized under analytical intent 406 and receive a constrained aggregate response, submit a second prompt categorized under personal lookup intent 408 and receive a scoped response limited to an authorized subset, and submit a third prompt categorized under export intent 412 and receive a denied response 428. Accordingly, the intent-policy matrix 400 provides a visual representation of how role-based and intent-based controls can be combined to govern semantic retrieval and AI-generated responses.

FIG. 4 illustrates one embodiment in which access control is based on an authorized user role and a permitted user intent associated with the query input, such that the system can control who can do what with which client data items and under which inference constraints while reducing unauthorized disclosure during restricted similarity search and restricted response generation.

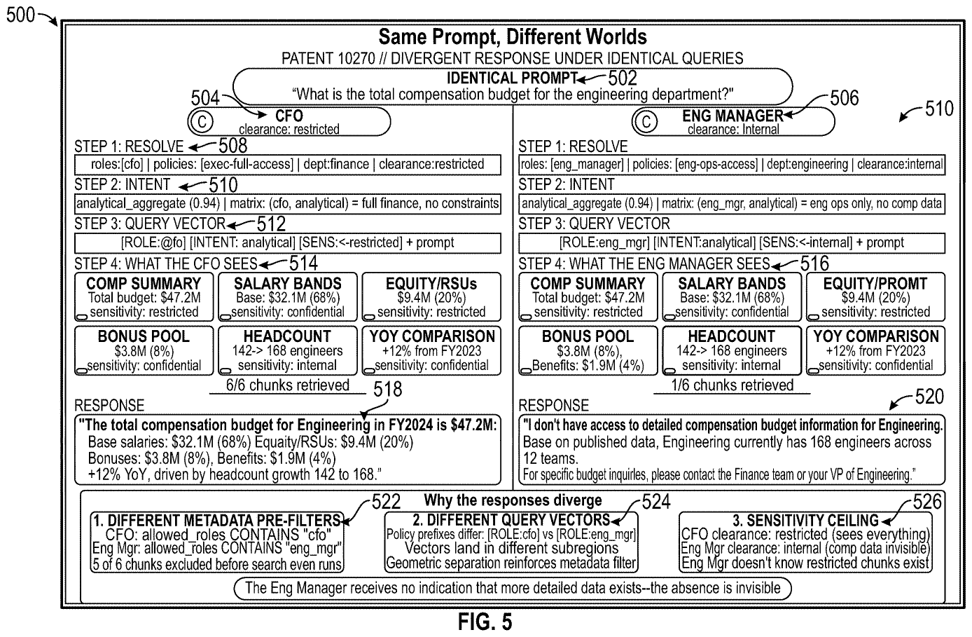

FIG. 5 shows a divergent response comparison 500, which supports techniques for tagging client data for role and intent-based access control in AI models in accordance with various aspects of the present disclosure. As depicted in FIG. 5, the divergent response comparison 500 may include one or more of an identical prompt 502, a chief financial officer (CFO) 504, an engineering manager 506, a first processing stage 508, a second processing stage 510, a third processing stage 512, a first result path 514, a second result path 516, a response for CFO 518, a response for engineering manager 520, metadata pre-filters 522, query vectors 524, and a sensitivity ceiling 526, and/or other components. FIG. 5 illustrates one embodiment in which a same query input is processed differently based on an authorized user role and an associated permitted user intent, such that a restricted response is generated from policy-compatible client data items while remaining subject to an inference constraint. FIG. 5 illustrates one embodiment in which a same query input is processed differently based on an authorized user role and an associated permitted user intent, such that a restricted response is generated from policy-compatible client data items while remaining subject to an inference constraint.

The identical prompt 502 may include a query submitted by different users to an artificial intelligence system. The identical prompt 502 may represent a textual input or question that users submit to interact with the system. The identical prompt 502 may be processed to determine its semantic meaning and intent. The identical prompt 502 may be analyzed to identify its relevance to specific data stored in the system. In some implementations, the identical prompt 502 may include examples such as “What is the total compensation budget for the engineering department?” or “What are the salary trends for senior engineers over the past three years?”

As shown, the identical prompt 502 is applied along separate processing paths associated with the chief financial officer (CFO) 504 and the engineering manager 506 so that access retrieval control and inference control can be enforced for the same underlying query input. The chief financial officer (CFO) 504 may represent a user role with access to restricted financial data. The chief financial officer (CFO) 504 may be associated with permissions that allow access to sensitive financial records, such as compensation breakdowns and budget allocations. The chief financial officer (CFO) 504 may submit queries that require detailed financial information. The chief financial officer (CFO) 504 may interact with the system to retrieve data relevant to their role. In some implementations, the chief financial officer (CFO) 504 may access data tagged with sensitivity classifications such as “restricted” or “confidential.”

The engineering manager 506 may represent a user role with access to operational and general data but limited access to financial details. The engineering manager 506 may have permissions to access data related to team headcounts, project statuses, and general operational metrics. The engineering manager 506 may submit queries that focus on non-sensitive information within their organizational scope. The engineering manager 506 may interact with the system to retrieve data relevant to their managerial responsibilities. In some implementations, the engineering manager 506 may be restricted from accessing data tagged with sensitivity classifications such as “restricted.”

The first processing stage 508 may determine the user access context based on the role and intent of the user submitting the query. The first processing stage 508 may retrieve the user's role and associated permissions from an enterprise identity service. The first processing stage 508 may analyze the query to classify the user's intent, such as analytical or personal data lookup. The first processing stage 508 may combine the user's role and intent to form a user access context. In some implementations, the first processing stage 508 may use an intent classification model to determine the intent associated with the query.

The second processing stage 510 may apply metadata pre-filters to restrict the candidate data set based on the user access context. The second processing stage 510 may construct a metadata filter expression that aligns with the user's role and intent. The second processing stage 510 may exclude data chunks that are incompatible with the user's access permissions. The second processing stage 510 may ensure that only authorized data is included in the candidate set for further processing. In some implementations, the second processing stage 510 may evaluate metadata fields such as allowed roles, sensitivity levels, and temporal validity.

The third processing stage 512 may execute a restricted similarity search to retrieve data compatible with the user access context. The third processing stage 512 may use a policy-conditioned query vector to perform the similarity search. The third processing stage 512 may rank the candidate data chunks based on their semantic relevance and policy compatibility. The third processing stage 512 may retrieve the top-ranked data chunks for inclusion in the response. In some implementations, the third processing stage 512 may perform an approximate nearest neighbor search within a vector data repository.

The first result path 514 may represent the processing flow for the chief financial officer (CFO) 504, leading to a detailed response. The first result path 514 may include the retrieval of data chunks tagged with high sensitivity levels, such as “restricted.” The first result path 514 may process the retrieved data to generate a response that aligns with the CFO's access permissions. The first result path 514 may ensure that the response includes detailed financial information relevant to the CFO's query. In some implementations, the first result path 514 may involve additional validation steps to confirm the compatibility of the retrieved data with the CFO's role.

The second result path 516 may represent the processing flow for the engineering manager 506, leading to a restricted response. The second result path 516 may include the retrieval of data chunks tagged with lower sensitivity levels, such as “internal.” The second result path 516 may process the retrieved data to generate a response that aligns with the engineering manager's access permissions. The second result path 516 may ensure that the response excludes sensitive financial details. In some implementations, the second result path 516 may involve additional checks to confirm that the retrieved data is within the engineering manager's authorized scope.

The response for CFO 518 may include detailed financial data retrieved based on the CFO's access permissions. The response for CFO 518 may present information such as budget breakdowns, salary distributions, and equity allocations. The response for CFO 518 may be tailored to the CFO's query and access context. The response for CFO 518 may ensure that the information provided is accurate and relevant to the CFO's role. In some implementations, the response for CFO 518 may include data tagged with sensitivity classifications such as “restricted.”

The response for engineering manager 520 may include general operational data without access to restricted financial details. The response for engineering manager 520 may present information such as team headcounts, project summaries, and published budget categories. The response for engineering manager 520 may be tailored to the engineering manager's query and access context. The response for engineering manager 520 may ensure that sensitive financial data is excluded. In some implementations, the response for engineering manager 520 may include data tagged with sensitivity classifications such as “internal.”

The metadata pre-filters 522 may limit the data retrieval scope by excluding unauthorized data based on user roles and intents. The metadata pre-filters 522 may evaluate metadata fields such as allowed roles, allowed intents, and sensitivity levels. The metadata pre-filters 522 may construct filter expressions to prune the candidate data set before similarity scoring. The metadata pre-filters 522 may ensure that only authorized data is considered for retrieval. In some implementations, the metadata pre-filters 522 may include conditions for temporal validity and data provenance.

The query vectors 524 may encode both the semantic content of the query and the access control context of the user. The query vectors 524 may be generated by prepending a policy prefix to the query text before embedding. The query vectors 524 may be positioned in the vector space to align with data chunks that are both semantically relevant and policy-compatible. The query vectors 524 may ensure that the similarity search retrieves data that matches the user's query and access context. In some implementations, the query vectors 524 may be generated using a fine-tuned embedding model.

The sensitivity ceiling 526 may determine the highest sensitivity level of the data retrieved for the query. The sensitivity ceiling 526 may be identified by evaluating the sensitivity classifications of the retrieved data chunks. The sensitivity ceiling 526 may constrain the selection of the artificial intelligence model used to process the query. The sensitivity ceiling 526 may ensure that data with high sensitivity levels are processed within secure environments. In some implementations, the sensitivity ceiling 526 may influence the routing of the query to a private or public model.

In some implementations, the identical prompt 502 may be processed differently based on the roles and access contexts of the chief financial officer (CFO) 504 and the engineering manager 506. The first processing stage 508 may resolve the user roles and applicable policies, generating metadata pre-filters 522 that restrict access to specific data chunks. The second processing stage 510 may determine query vectors 524 by incorporating the resolved metadata and intent classifications into the embedding process. The third processing stage 512 may execute a restricted similarity search, applying the metadata pre-filters 522 and query vectors 524 to retrieve policy-compatible data chunks.

In some implementations, the first result path 514 and the second result path 516 may diverge based on the sensitivity ceiling 526 applied to the retrieved data. The response for CFO 518 may include detailed financial information, such as compensation budgets and salary bands, while the response for the engineering manager 520 may exclude such details, reflecting the access restrictions encoded in the metadata pre-filters 522 and query vectors 524. The sensitivity ceiling 526 may act as an additional constraint, limiting the visibility of sensitive data to users with appropriate clearance levels.

Accordingly, FIG. 5 demonstrates how a same prompt can produce different restricted responses through coordinated use of user access context determination, metadata pre-filtering, query vector generation, restricted similarity search, and sensitivity-based inference control.

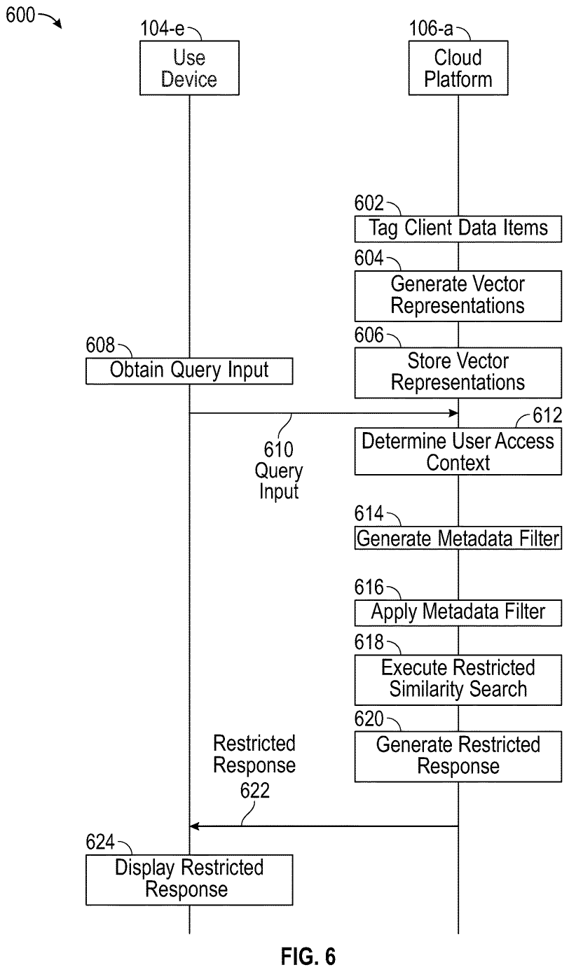

FIG. 6 illustrates an example of a process flow 600 that supports tagging client data for role and intent-based access control in AI models in accordance with aspects of the present disclosure. In some examples, the process flow 600 may implement aspects of the system 100. For example, the process flow 600 may include a user device 104-e and a cloud platform 106-a, which may be examples of corresponding devices described herein. In some implementations, a cloud platform 106-a receives client data items, tags them with access control metadata, generates vector representations, stores them in a searchable repository, processes a query input from a user device 104-e by determining a user access context, applies a metadata filter to limit candidate vector representations, executes a restricted similarity search, and generates a restricted response using an AI model based on policy-compatible client data items.

At 602, the cloud platform 106-a may tag the client data items with access control metadata for access retrieval control and inference control, the access control metadata indicating an authorized user role and a permitted user intent for each of the client data items. For example, the cloud platform 106-a may assign sensitivity classifications such as public, internal, confidential, or restricted to the client data items based on their content. In some implementations, the cloud platform 106-a may include temporal validity tags, such as valid_after or expires, to specify time windows during which the client data items may be accessible. The cloud platform 106-a may determine role-scope indicators for the client data items, such as allowed_roles, to define which user roles may access specific data items.

In some embodiments, 604, corresponding to tagging client data, is performed during a setup stage prior to receipt of a user query. For example, during setup time, client data items may be received, analyzed, and tagged with access control metadata including role permissions, permitted intents, sensitivity classifications, temporal validity conditions, inference control flags, or combinations thereof. The tagged client data items can then be embedded and stored in a searchable data repository for subsequent restricted retrieval.

At inference time, the system need not repeat the tagging operation of 606 for each received user query. Instead, the system can use metadata generated during the setup stage to perform access-context determination, metadata filtering, restricted similarity search, inference control evaluation, and restricted response generation in response to the user query.

At 604, the cloud platform 106-a may generate, using an embedding model, vector representations for the client data items based on content of the client data items and the access control metadata associated with the client data items. For example, the cloud platform 106-a may prepend a structured policy prefix to the text of the client data items before inputting them into the embedding model, where the policy prefix may include tags such as sensitivity classifications, role-scope indicators, and intent-scope indicators. In some implementations, the embedding model may be fine-tuned to encode both the semantic content and the access control metadata into the resulting vector representations, ensuring that the vectors may occupy distinct regions of the embedding space based on their associated metadata. In other implementations, the embedding model may rely on the policy prefix alone to influence the geometric positioning of the vector representations in the embedding space.

At 616, the cloud platform 106-a may store the vector representations and the access control metadata in a searchable data repository. For example, the cloud platform 106-a may store the vector representations as high-dimensional float arrays alongside structured metadata fields, such as sensitivity classifications, role-scope indicators, and temporal validity tags, to enable efficient filtering during retrieval. In some implementations, the cloud platform 106-a may include cryptographic hashes of the original client data items in the metadata fields to support integrity verification and audit processes. The cloud platform 106-a may organize the stored data in a manner that allows approximate nearest neighbor searches on the vector representations while supporting exact-match filtering on the metadata fields.

At 608, the user device 104-e may obtain a query input from a user. For example, the user device 104-e may receive a text-based query input entered through a keyboard interface. In some implementations, the user device 104-e may capture a voice-based query input through a microphone, which may then be processed into text. The user device 104-e may additionally interpret a query input provided through a touch-based gesture on a graphical user interface.

At 610, the user device 104-e may transmit the query input to the cloud platform 106-a. For example, the user device 104-e may send the query input as a structured data packet over a secure communication channel to the cloud platform 106-a. In some implementations, the user device 104-e may encrypt the query input before transmission to ensure compatibility with the cloud platform 106-a's decryption protocols. The user device 104-e may include metadata with the query input, such as a timestamp or user access context, to assist the cloud platform 106-a in processing the input.

At 612, the cloud platform 106-a may determine, based on the query input and an access profile of the requesting user, a user access context comprising a role of the requesting user and an intent associated with the query input. For example, the cloud platform 106-a may analyze the query input using an intent classification model to identify whether the intent may correspond to categories such as analytical_aggregate, personal_data_lookup, or compliance_audit. In some implementations, the cloud platform 106-a may reference historical behavior or session context to refine the intent determination, such as reclassifying the intent if sequential queries suggest a shift in the user's purpose. The cloud platform 106-a may incorporate administrator-defined overrides to enforce specific intent constraints for particular roles, such as assigning compliance_audit intent to external_auditor roles regardless of the detected intent.

At 614, the cloud platform 106-a may generate, from the user access context, a metadata filter and a query vector representation. For example, the metadata filter may include conditions such as allowed_roles, sensitivity levels, and temporal validity tags to restrict the candidate set of data items. In some implementations, the query vector representation may incorporate a structured policy prefix that encodes the requesting user's role and intent, influencing the geometric positioning of the vector in the embedding space. The cloud platform 106-a may determine the metadata filter to exclude data items that do not align with the requesting user's access profile or the detected intent.

At 616, the cloud platform 106-a may apply the metadata filter to limit, before similarity scoring, a candidate set of the vector representations to vector representations having access control metadata compatible with the user access context. For example, the metadata filter may include conditions such as allowed_roles, sensitivity classifications, and temporal validity tags to exclude vector representations that do not align with the requesting user's access profile. In some implementations, the metadata filter may be configured to prioritize vector representations with higher compatibility scores based on the user's role and detected intent. The cloud platform 106-a may dynamically adjust the metadata filter to account for session-specific parameters, such as changes in the user's intent or updates to access control policies during the session.

At 618, the cloud platform 106-a may execute a restricted similarity search in the searchable data repository using the query vector representation against the candidate set of the vector representations to retrieve policy-compatible client data items. For example, the cloud platform 106-a may perform the restricted similarity search by leveraging approximate nearest neighbor techniques to identify vector representations that align with the requesting user's access context. In some implementations, the cloud platform 106-a may adjust similarity scoring to prioritize vector representations that exhibit higher compatibility with the user's role and detected intent. The cloud platform 106-a may exclude vector representations that contain metadata indicating conflicting access control policies or inference constraints.

At 620, the cloud platform 106-a may generate, using the Artificial Intelligence (AI) model and subject to an inference constraint associated with the policy-compatible client data items, a restricted response based on the policy-compatible client data items. For example, the cloud platform 106-a may generate a response that includes aggregate statistical data derived from the policy-compatible client data items while omitting individual-level details. In some implementations, the cloud platform 106-a may apply redaction techniques to remove sensitive information from the response if the inference constraint indicates that direct citation of specific data items may not be permitted. The cloud platform 106-a may determine whether the response aligns with the user's detected intent and access profile before finalizing the restricted response.

At 622, the cloud platform 106-a may transmit the restricted response to the user device 104-e. For example, the cloud platform 106-a may send the restricted response as a structured data packet over a secure communication channel to the user device 104-e. In some implementations, the cloud platform 106-a may encrypt the restricted response before transmission to align with security protocols associated with the user device 104-e. The cloud platform 106-a may include metadata with the restricted response, such as a timestamp or sensitivity classification, to assist the user device 104-e in interpreting the response.

At 624, the user device 104-e may display the restricted response to the user. For example, the user device 104-e may render the restricted response as a text-based message on a graphical user interface, allowing the user to view the information in a structured format. In some implementations, the user device 104-e may present the restricted response through a voice output system, converting the text into synthesized speech for auditory delivery. The user device 104-e may include visual indicators, such as icons or color-coded highlights, to signify the sensitivity level of the displayed response.

Accordingly, FIG. 6 illustrates an embodiment in which tagging, embedding, storage, access-context determination, metadata filtering, restricted similarity search, and restricted response generation are coordinated between the user device 104-e and the cloud platform 106-a to reduce unauthorized disclosure while supporting policy-compatible retrieval and inference.

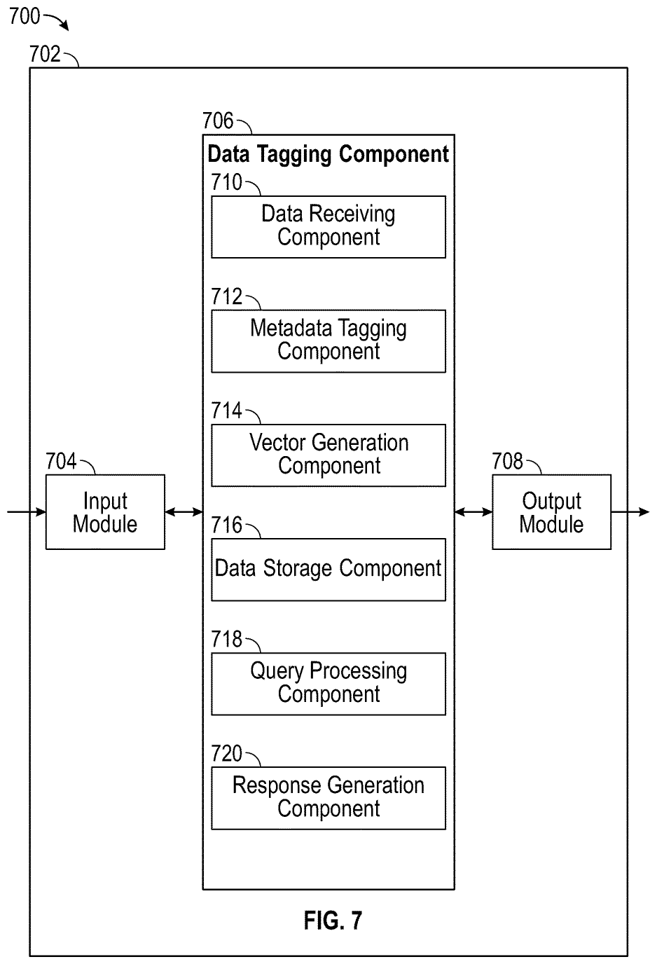

FIG. 7 shows a block diagram 700 of an apparatus 702 that supports tagging client data for role and intent-based access control in AI models in accordance with various aspects of the present disclosure. The apparatus 702 may include an input module 704, a data tagging component 706, and an output module 708. The apparatus 702 may also include a processor. Each of these components may be in communication with one another (e.g., via one or more buses). In some cases, the apparatus 702 may be an example of a user terminal, a database server, or a system containing multiple computing devices.

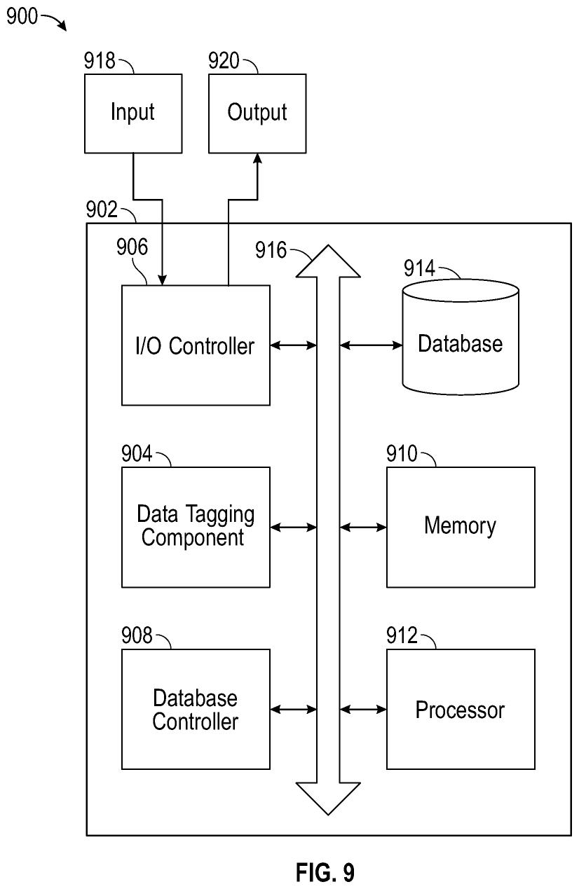

The input module 704 may manage input signals for the apparatus 702. For example, the input module 704 may identify input signals based on an interaction with a modem, a keyboard, a mouse, a touchscreen, or a similar device. These input signals may be associated with user input or processing at other components or devices. In some cases, the input module 704 may utilize an operating system such as iOS®, ANDROID®, MS-DOS®, MS-WINDOWS®, OS/2®, UNIX®, LINUX®, or another known operating system to handle input signals. The input module 704 may send aspects of these input signals to other components of the apparatus 702 for processing. In some cases, the input module 704 may be a component of an input/output (I/O) controller 906 as described with reference to FIG. 9.

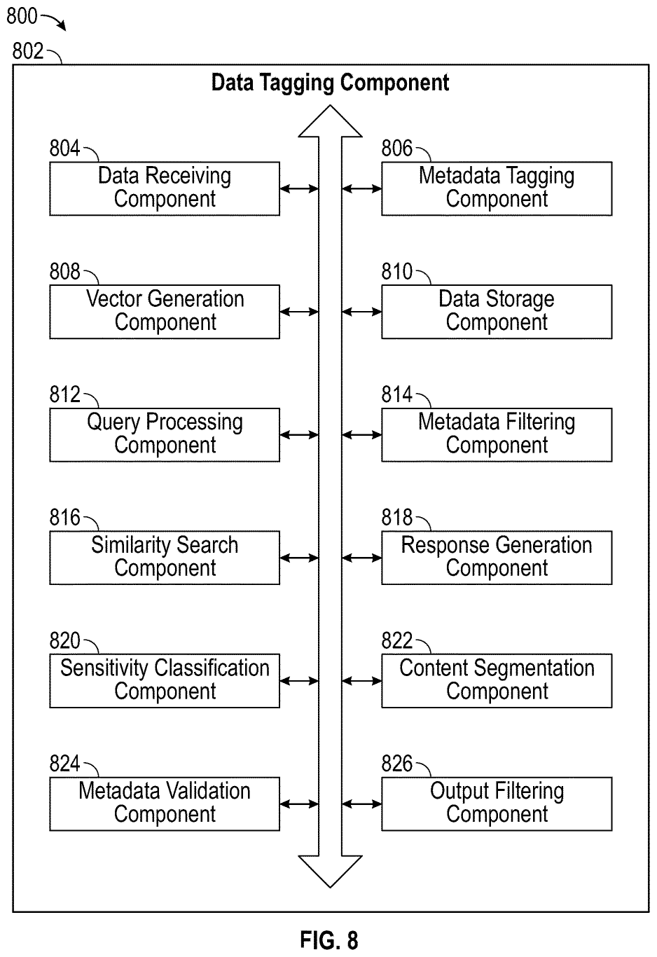

The data tagging component 706 may include one or more of a data receiving component 710, a metadata tagging component 712, a vector generation component 714, a data storage component 716, a query processing component 718, a response generation component 720, and/or other components. The data tagging component 706 may be an example of aspects of the data tagging component 802 or 904 described with reference to FIG. 8 and FIG. 9.

The data receiving component 710 may be configured as or otherwise support a means for receiving client data items. The metadata tagging component 712 may be configured as or otherwise support a means for tagging the client data items with access control metadata for access retrieval control and inference control, wherein the access control metadata may indicate an authorized user role and a permitted user intent for each of the client data items. The vector generation component 714 may be configured as or otherwise support a means for generating, using an embedding model, vector representations for the client data items based on the content of the client data items and the access control metadata associated with the client data items. The data storage component 716 may be configured as or otherwise support a means for storing the vector representations and the access control metadata in a searchable data repository. The query processing component 718 may be configured as or otherwise support a means for receiving a query input from a requesting user, determining, based on the query input and an access profile of the requesting user, a user access context comprising a role of the requesting user and an intent associated with the query input, generating, from the user access context, a metadata filter and a query vector representation, and applying the metadata filter to limit, before similarity scoring, a candidate set of the vector representations to vector representations having access control metadata compatible with the user access context. The query processing component 718 may further be configured as or otherwise support a means for executing a restricted similarity search in the searchable data repository using the query vector representation against the candidate set of the vector representations to retrieve policy-compatible client data items. The response generation component 720 may be configured as or otherwise support a means for generating, using the AI model and subject to an inference constraint associated with the policy-compatible client data items, a restricted response based on the policy-compatible client data items.

The output module 708 may manage output signals for the apparatus 702. For example, the output module 708 may receive signals from other components of the apparatus 702, such as the data tagging component 706, and may transmit these signals to other components or devices. In some specific examples, the output module 708 may transmit output signals for display in a user interface, for storage in a database or data store, for further processing at a server or server cluster, or for any other processes at any number of devices or systems. In some cases, the output module 708 may be a component of an I/O controller 906 as described with reference to FIG. 9.

FIG. 8 shows a block diagram 800 of a data tagging component 802 that supports tagging client data for role and intent-based access control in AI models in accordance with various aspects of the present disclosure. The data tagging component 802 may be an example of aspects of a data tagging component 706, a data tagging component 904, or both, as described herein. The data tagging component 802, or various components thereof, may be an example of means for performing various aspects of tagging client data for role and intent-based access control in AI models as described herein. For example, the data tagging component 802 may include one or more of a data receiving component 804, a metadata tagging component 806, a vector generation component 808, a data storage component 810, a query processing component 812, a metadata filtering component 814, a similarity search component 816, a response generation component 818, a sensitivity classification component 820, a content segmentation component 822, a metadata validation component 824, an output filtering component 826, and/or other components. Each of these components may communicate, directly or indirectly, with one another (e.g., via one or more buses).

The data receiving component 804 may be configured as or otherwise support a means for receiving client data items. In some implementations, the data receiving component 804 may include an interface that may support secure data transfer protocols to handle sensitive client data items. The data receiving component 804 may, in some cases, incorporate automated classifiers that may determine the sensitivity level of incoming client data items during the initial receipt process. The data receiving component 804 may, in certain configurations, support integration with external systems, such as HR or financial platforms, to receive client data items tagged with preliminary metadata.

The metadata tagging component 806 may be configured as or otherwise support a means for tagging the client data items with access control metadata for access retrieval control and inference control; the access control metadata may indicate an authorized user role and a permitted user intent for each of the client data items. In some implementations, the metadata tagging component 806 may assign hierarchical sensitivity classifications, such as public, internal, confidential, or restricted, to reflect varying levels of data sensitivity. The metadata tagging component 806 may, in certain configurations, incorporate role-scope indicators that may specify allowlisted roles, such as hr_manager or finance_analyst, authorized to access specific client data items. The metadata tagging component 806 may, in some cases, attach intent-scope indicators that may define permitted intents, such as analytical_aggregate or personal_data_lookup, for accessing the client data items.

The vector generation component 808 may be configured as or otherwise support a means for generating, using an embedding model, vector representations for the client data items based on content of the client data items and the access control metadata associated with the client data items. In some implementations, the vector generation component 808 may incorporate a fine-tuned transformer model that may embed policy-conditioned prefixes into the vector representations. The vector generation component 808 may, in certain configurations, support embeddings that may encode both semantic content and access control metadata into distinct subregions of the vector space. The vector generation component 808 may, in some cases, generate embeddings that may reflect hierarchical sensitivity classifications, such as confidential or restricted, to align with the metadata tagging component 806.

The data storage component 810 may be configured as or otherwise support a means for storing the vector representations and the access control metadata in a searchable data repository. In some implementations, the data storage component 810 may store vector representations in a format that may support approximate nearest neighbor search to determine semantically similar entries. The data storage component 810 may, in certain configurations, include metadata fields that may be indexed to allow for efficient filtering based on access control criteria. The data storage component 810 may, in some cases, store cryptographic hashes of the original client data items to support integrity verification during retrieval operations.

The query processing component 812 may be configured as or otherwise support a means for receiving a query input from a requesting user and determining, based on the query input and an access profile of the requesting user, a user access context comprising a role of the requesting user and an intent associated with the query input. In some implementations, the query processing component 812 may receive query inputs through a secure interface that may support encrypted communication protocols to handle sensitive user queries. The query processing component 812 may, in certain configurations, incorporate natural language processing models that may interpret the semantic meaning of the query input to determine its intent. The query processing component 812 may, in some cases, retrieve the requesting user's access profile from an enterprise identity service that may include role-based permissions and historical interaction data.

The metadata filtering component 814 may be configured as or otherwise support a means for generating, from the user access context, a metadata filter and a query vector representation, and applying the metadata filter to limit, before similarity scoring, a candidate set of the vector representations to vector representations having access control metadata compatible with the user access context. In some implementations, the metadata filtering component 814 may determine the metadata filter by evaluating hierarchical sensitivity classifications, such as public, internal, confidential, or restricted, associated with the vector representations. In some implementations, the metadata filtering component 814 may incorporate temporal validity tags to exclude vector representations that are not valid at the time of the query input. In some implementations, the metadata filtering component 814 may support filtering based on role-scope indicators, such as allowlisted roles like hr_manager or finance_analyst, to ensure compatibility with the user access context.

The similarity search component 816 may be configured as or otherwise support a means for executing a restricted similarity search in the searchable data repository using the query vector representation against the candidate set of the vector representations to retrieve policy-compatible client data items. In some implementations, the similarity search component 816 may determine semantic relevance by comparing the query vector representation to the geometric positions of the candidate vector representations in the vector space. In some implementations, the similarity search component 816 may incorporate policy-conditioned scoring to prioritize vector representations that align with the access control metadata of the requesting user. In some implementations, the similarity search component 816 may retrieve a predefined number of top-ranked vector representations based on their similarity scores relative to the query vector representation.

The response generation component 818 may be configured as or otherwise support a means for generating, using the AI model and subject to an inference constraint associated with the policy-compatible client data items, a restricted response based on the policy-compatible client data items. In some implementations, the response generation component 818 may determine whether the restricted response includes aggregate data by evaluating the inference control flags associated with the policy-compatible client data items. In some implementations, the response generation component 818 may incorporate redaction mechanisms to remove sensitive content from the restricted response that may originate from the AI model's parametric memory. In some implementations, the response generation component 818 may apply formatting rules to the restricted response to align with organizational guidelines or compliance requirements.

In some examples, the sensitivity classification component 820 may be configured as or otherwise support a means for assigning, during the tagging, a sensitivity classification to the client data items; the sensitivity classification may be selected from a hierarchy including public, internal, confidential, and restricted, and storing the sensitivity classification may be as part of the access control metadata in the searchable data repository. In some implementations, the sensitivity classification component 820 may determine the sensitivity classification based on predefined rules that may map specific data sources to corresponding sensitivity levels. In some implementations, the sensitivity classification component 820 may incorporate automated classifiers that may analyze the content of the client data items to identify sensitive information, such as personally identifiable information or financial data, and assign an appropriate sensitivity classification. In some implementations, the sensitivity classification component 820 may allow administrators to manually override or adjust the assigned sensitivity classification through an administrative interface to reflect organizational policies.

In some examples, the content segmentation component 822 may be configured as or otherwise support a means for segmenting the client data items into chunks prior to generating the vector representations, wherein each chunk may inherit document-level access control metadata and may be further tagged with chunk-specific metadata based on content analysis of the chunk. In some implementations, the content segmentation component 822 may segment client data items based on structural boundaries, such as sections, tables, or paragraphs, to align with the logical organization of the content. In some implementations, the content segmentation component 822 may determine chunk boundaries by analyzing semantic coherence within the text, such as identifying topic shifts or changes in subject matter. In some implementations, the content segmentation component 822 may apply a fixed-size windowing approach with overlapping regions to ensure that contextual relationships between adjacent chunks are preserved.

In some examples, the metadata tagging component 806 may be configured as or otherwise support a means for constructing a structured policy prefix from the access control metadata associated with the client data items, prepending the structured policy prefix to the text of the client data items, and embedding the policy-augmented text to generate the vector representations. In some implementations, the metadata tagging component 806 may determine the structured policy prefix by combining multiple metadata fields, such as sensitivity classifications, role-scope indicators, and intent-scope indicators, into a standardized format. In some implementations, the metadata tagging component 806 may include a mechanism to encode temporal validity tags into the structured policy prefix to reflect time-based access restrictions. In some implementations, the metadata tagging component 806 may support the inclusion of cryptographic identifiers in the structured policy prefix to ensure the integrity of the metadata during subsequent processing steps.

In some examples, the metadata validation component 824 may be configured as or otherwise support a means for validating, after storing the vector representations, that each stored vector representation may include a complete and consistent set of access control metadata, and quarantining any vector representation missing required metadata for administrative review. In some implementations, the metadata validation component 824 may determine whether the access control metadata includes all required fields, such as sensitivity classifications, role-scope indicators, and intent-scope indicators. In some implementations, the metadata validation component 824 may incorporate automated checks to identify inconsistencies, such as mismatched sensitivity levels or missing temporal validity tags, within the stored metadata. In some implementations, the metadata validation component 824 may flag vector representations with incomplete metadata for manual inspection by administrators to determine whether the missing metadata can be corrected or if the vector representation should remain quarantined.

In some examples, the output filtering component 826 may be configured as or otherwise support a means for applying an output filter to the restricted response generated by the AI model; the output filter may be configured to redact restricted content derived from parametric memory of the AI model that may not be included in the retrieved policy-compatible client data items. In some implementations, the output filtering component 826 may determine whether specific terms or phrases in the restricted response align with sensitive content patterns stored in a predefined redaction rule set. In some implementations, the output filtering component 826 may incorporate natural language processing techniques to identify and redact sensitive entities, such as names, financial figures, or proprietary terms, that may not be authorized for inclusion in the restricted response. In some implementations, the output filtering component 826 may apply configurable thresholds to determine whether ambiguous content should be flagged for redaction or retained in the restricted response.

In some examples, the metadata tagging component 806 may be configured as or otherwise support a means for executing an automated classifier during receipt of the client data items to detect sensitive content and may assign a sensitivity classification included in the access control metadata. In some implementations, the metadata tagging component 806 may determine sensitive content by analyzing patterns indicative of personally identifiable information, such as names, social security numbers, or email addresses. In some implementations, the metadata tagging component 806 may incorporate machine learning models trained on datasets containing examples of financial data, trade secrets, or other confidential information to identify sensitive content. In some implementations, the metadata tagging component 806 may assign sensitivity classifications based on predefined organizational policies that map specific data types, such as medical records or payroll data, to hierarchical sensitivity levels.

In some examples, the data storage component 810 may be configured as or otherwise support a means for storing the access control metadata as filterable metadata fields alongside respective ones of the vector representations. In some implementations, the data storage component 810 may store access control metadata in a structured format that may allow for efficient querying based on hierarchical sensitivity classifications. In some implementations, the data storage component 810 may include mechanisms to index metadata fields, such as role-scope indicators or intent-scope indicators, to streamline filtering operations during retrieval processes.

In some examples, the query processing component 812 may be configured as or otherwise support a means for applying an intent classification model to the query input to identify the intent associated with the query input. In some implementations, the query processing component 812 may determine the intent by analyzing linguistic patterns in the query input, such as specific keywords or phrases that may indicate a particular intent category. In some implementations, the query processing component 812 may incorporate a confidence scoring mechanism that may assign a probability to each potential intent, allowing for the selection of the intent with the highest likelihood.

In some examples, the query processing component 812 may be configured as or otherwise support a means for updating an output of the intent classification model based on prior prompts received during a session of the requesting user. In some implementations, the query processing component 812 may determine patterns in the sequence of prior prompts to refine the detected intent for the current query. In some implementations, the query processing component 812 may incorporate temporal analysis to evaluate how the timing of prior prompts may influence the intent classification. In some implementations, the query processing component 812 may assess whether prior prompts exhibit a progression in specificity that may indicate a shift in the user's intent.

In some examples, the metadata filtering component 814 may be configured as or otherwise support a means for admitting a vector representation when the access control metadata of the vector representation may be compatible with any one of a plurality of roles associated with the requesting user. In some implementations, the metadata filtering component 814 may determine compatibility by evaluating role-scope indicators, such as allowlisted roles like hr_manager or finance_analyst, that may be associated with the vector representation. In some implementations, the metadata filtering component 814 may incorporate hierarchical sensitivity classifications, such as public, internal, confidential, or restricted, to further refine the admission criteria for the vector representation. In some implementations, the metadata filtering component 814 may assess temporal validity tags to determine whether the vector representation may be valid for access at the time of the query input.

In some examples, the metadata filtering component 814 may be configured as or otherwise support a means for including a temporal validity condition that may require access control metadata of an admitted vector representation to indicate current validity at a time of the restricted similarity search. In some implementations, the metadata filtering component 814 may determine temporal validity by evaluating timestamps associated with the vector representation, such as a valid_from field indicating the earliest permissible access time. In some implementations, the metadata filtering component 814 may incorporate expiration timestamps, such as a valid_until field, to exclude vector representations that may no longer be valid for access. In some implementations, the metadata filtering component 814 may assess whether the current system time falls within the temporal range defined by the access control metadata to determine compatibility.

In some examples, the similarity search component 816 may be configured as or otherwise support a means for performing an approximate neighbor search over the candidate set of the vector representations. In some implementations, the similarity search component 816 may determine proximity by evaluating the geometric distances between the query vector representation and the candidate vector representations in the vector space. In some implementations, the similarity search component 816 may incorporate a scoring mechanism that may prioritize candidate vector representations based on their alignment with the policy-conditioned query vector. In some implementations, the similarity search component 816 may retrieve a predefined number of top-ranked vector representations that may exhibit the highest similarity scores relative to the query vector representation.

In some examples, the similarity search component 816 may be configured as or otherwise support a means for evaluating retrieved client data items against one or more inference control flags and removing a retrieved client data item that may violate the one or more inference control flags. In some implementations, the similarity search component 816 may determine whether a retrieved client data item includes an aggregation-only flag that may restrict its use to statistical summaries. In some implementations, the similarity search component 816 may assess whether a retrieved client data item includes a cross-reference restriction flag that may prevent its combination with data from other sensitivity domains. In some implementations, the similarity search component 816 may evaluate whether a retrieved client data item meets a k-anonymity threshold that may require a minimum number of similar data items to maintain anonymity.

In some examples, the similarity search component 816 may be configured as or otherwise support a means for ensuring that the one or more inference control flags may comprise an aggregation-only flag and a minimum k-anonymity threshold for an aggregate response. In some implementations, the similarity search component 816 may determine whether the aggregation-only flag restricts the response to statistical summaries without revealing individual data points. In some implementations, the similarity search component 816 may assess whether the aggregation-only flag applies to specific data types, such as financial records or employee statistics, to tailor the response accordingly. In some implementations, the similarity search component 816 may evaluate the k-anonymity threshold by determining whether the retrieved data set includes a sufficient number of similar entries to maintain anonymity. In some implementations, the similarity search component 816 may determine whether the k-anonymity threshold is dynamically adjusted based on the sensitivity classification of the retrieved data items.

In some examples, the similarity search component 816 may be configured as or otherwise support a means for ensuring that the one or more inference control flags may comprise a cross-reference restriction that may prevent combining a first retrieved client data item from a first sensitivity domain with a second retrieved client data item from a second sensitivity domain in the restricted response. In some implementations, the similarity search component 816 may determine whether the cross-reference restriction applies to specific sensitivity domains, such as confidential financial data and restricted medical records, to maintain separation between these domains. In some implementations, the similarity search component 816 may assess whether the retrieved client data items include metadata tags that may explicitly indicate cross-reference restrictions, such as a flag prohibiting the combination of sensitive employee data with operational statistics. In some implementations, the similarity search component 816 may evaluate whether the cross-reference restriction is dynamically adjusted based on the detected intent of the query input, such as distinguishing between analytical_aggregate and personal_data_lookup intents.

In some examples, the response generation component 818 may be configured as or otherwise support a means for selecting, from a plurality of AI models, the AI model based on an uppermost sensitivity classification among the policy-compatible client data items retrieved by the restricted similarity search. In some implementations, the response generation component 818 may determine the uppermost sensitivity classification by evaluating hierarchical metadata tags, such as public, internal, confidential, or restricted, associated with the retrieved client data items. In some implementations, the response generation component 818 may incorporate a rule-based system to map sensitivity classifications to eligible AI models, such as assigning restricted data to a private, self-hosted model. In some implementations, the response generation component 818 may assess whether the selected AI model supports specific compliance requirements, such as data residency or encryption standards, based on the sensitivity classification.

In some examples, the query processing component 812 may be configured as or otherwise support a means for processing the query input from the requesting user as a prompt. In some implementations, the query processing component 812 may determine the semantic structure of the prompt by analyzing linguistic patterns such as sentence syntax or keyword frequency. In some implementations, the query processing component 812 may incorporate a natural language understanding model that may identify contextual nuances in the prompt, such as implied questions or indirect requests. In some implementations, the query processing component 812 may evaluate the prompt for domain-specific terminology that may indicate specialized intent categories, such as legal analysis or financial reporting. Accordingly, FIG. 8 illustrates a component-level configuration in which retrieval operations and response generation may be constrained using access control metadata so that the data tagging component 802 supports role and intent-based access control in AI models.

FIG. 9 shows a diagram of a system 900 including a device 902 that supports tagging client data for role and intent-based access control in AI models in accordance with aspects of the present disclosure. The device 902 may be an example of or include the components of a database server or an apparatus 702 as described herein. The device 902 may include components for bi-directional data communications, including components for transmitting and receiving communications, including a data tagging component 904, an I/O controller 906, a database controller 908, memory 910, a processor 912, and a database 914. These components may be in electronic communication via one or more buses (e.g., bus 916).

The data tagging component 904 may be an example of a data tagging component 706 or 802 as described herein. For example, the data tagging component 904 may perform any of the methods or processes described above with reference to FIG. 7 and FIG. 8. In some cases, the data tagging component 904 may be implemented in hardware, software executed by a processor, firmware, or any combination thereof.

The I/O controller 906 may manage input signals 918 and output signals 920 for the device 902. The I/O controller 906 may also manage peripherals not integrated into the device 902. In some cases, the I/O controller 906 may represent a physical connection or port to an external peripheral. In some cases, the I/O controller 906 may utilize an operating system such as iOS®, ANDROID®, MS-DOS®, MS-WINDOWS®, OS/2®, UNIX®, LINUX®, or another known operating system. In other cases, the I/O controller 906 may represent or interact with a modem, a keyboard, a mouse, a touchscreen, or a similar device. In some cases, the I/O controller 906 may be implemented as part of a processor. In some cases, a user may interact with the device 902 via the I/O controller 906 or via hardware components controlled by the I/O controller 906.

The database controller 908 may manage data storage and processing in a database 914. In some cases, a user may interact with the database controller 908. In other cases, the database controller 908 may operate automatically without user interaction. The database 914 may be an example of a single database, a distributed database, multiple distributed databases, a data store, a data lake, or an emergency backup database.

Memory 910 may include random-access memory (RAM) and read-only memory (ROM). The memory 910 may store computer-readable, computer-executable software including instructions that, when executed, cause the processor to perform various functions described herein. In some cases, the memory 910 may contain, among other things, a basic input/output system (BIOS) that may control basic hardware or software operation, such as the interaction with peripheral components or devices.

The processor 912 may include an intelligent hardware device (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 912 may be configured to operate a memory array using a memory controller. In other cases, a memory controller may be integrated into the processor 912. The processor 912 may be configured to execute computer-readable instructions stored in a memory 910 to perform various functions (e.g., functions or tasks supporting tagging client data for role and intent-based access control in AI models).

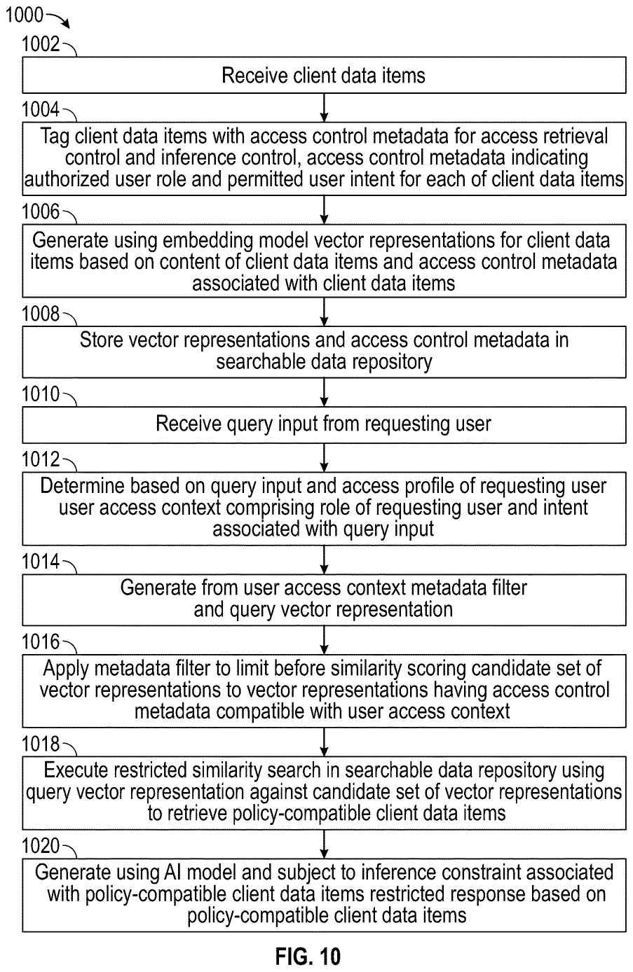

FIG. 10 shows a flowchart illustrating a method 1000 that supports tagging client data for role and intent-based access control in AI models in accordance with various aspects of the present disclosure. The operations of the method 1000 may be implemented by one or more components of a networked computing system as described herein. For example, the operations of the method 1000 may be performed by a data tagging component as described with reference to FIG. 7 through FIG. 9. In some examples, one or more components of a networked computing system may execute a set of instructions to control the functional elements of the component(s) to perform the described functions. Additionally or alternatively, the one or more components of a networked computing system may perform aspects of the described functions using special-purpose hardware.

At 1002, the method 1000 may include receiving client data items. The operations of 1002 may be performed in accordance with examples as disclosed herein. In some examples, aspects of the operations of 1002 may be performed by a data receiving component 804 as described with reference to FIG. 8.

At 1004, the method 1000 may include tagging the client data items with access control metadata for access retrieval control and inference control, the access control metadata indicating an authorized user role and a permitted user intent for each of the client data items. The operations of 1004 may be performed in accordance with examples as disclosed herein. In some examples, aspects of the operations of 1004 may be performed by a metadata tagging component 806 as described with reference to FIG. 8.

At 1006, the method 1000 may include generating, using an embedding model, vector representations for the client data items based on content of the client data items and the access control metadata associated with client data items. The operations of 1006 may be performed in accordance with examples as disclosed herein. In some examples, aspects of the operations of 1006 may be performed by a vector generation component 808 as described with reference to FIG. 8.

At 1008, the method 1000 may include storing the vector representations and the access control metadata in a searchable data repository. The operations of 1008 may be performed in accordance with examples as disclosed herein. In some examples, aspects of the operations of 1008 may be performed by a data storage component 810 as described with reference to FIG. 8.

At 1010, the method 1000 may include receiving a query input from a requesting user. The operations of 1010 may be performed in accordance with examples as disclosed herein. In some examples, aspects of the operations of 1010 may be performed by a query processing component 812 as described with reference to FIG. 8.

At 1012, the method 1000 may include determining, based on the query input and an access profile of the requesting user, a user access context comprising a role of the requesting user and an intent associated with the query input. The operations of 1012 may be performed in accordance with examples as disclosed herein. In some examples, aspects of the operations of 1012 may be performed by a sensitivity classification component 820 as described with reference to FIG. 8.

At 1014, the method 1000 may include generating, from the user access context, a metadata filter and a query vector representation. The operations of 1014 may be performed in accordance with examples as disclosed herein. In some examples, aspects of the operations of 1014 may be performed by a metadata filtering component 814 as described with reference to FIG. 8.

At 1016, the method 1000 may include applying the metadata filter to limit, before similarity scoring, a candidate set of the vector representations to vector representations having access control metadata compatible with the user access context. The operations of 1016 may be performed in accordance with examples as disclosed herein. In some examples, aspects of the operations of 1016 may be performed by a metadata validation component 824 as described with reference to FIG. 8.

At 1018, the method 1000 may include executing a restricted similarity search in the searchable data repository using the query vector representation against the candidate set of the vector representations to retrieve policy-compatible client data items. The operations of 1018 may be performed in accordance with examples as disclosed herein. In some examples, aspects of the operations of 1018 may be performed by a similarity search component 816 as described with reference to FIG. 8.

At 1020, the method 1000 may include generating, using the Artificial Intelligence (AI) model and subject to an inference constraint associated with the policy-compatible client data items, a restricted response based on the policy-compatible client data items. The operations of 1020 may be performed in accordance with examples as disclosed herein. In some examples, aspects of the operations of 1020 may be performed by a response generation component 818 as described with reference to FIG. 8.

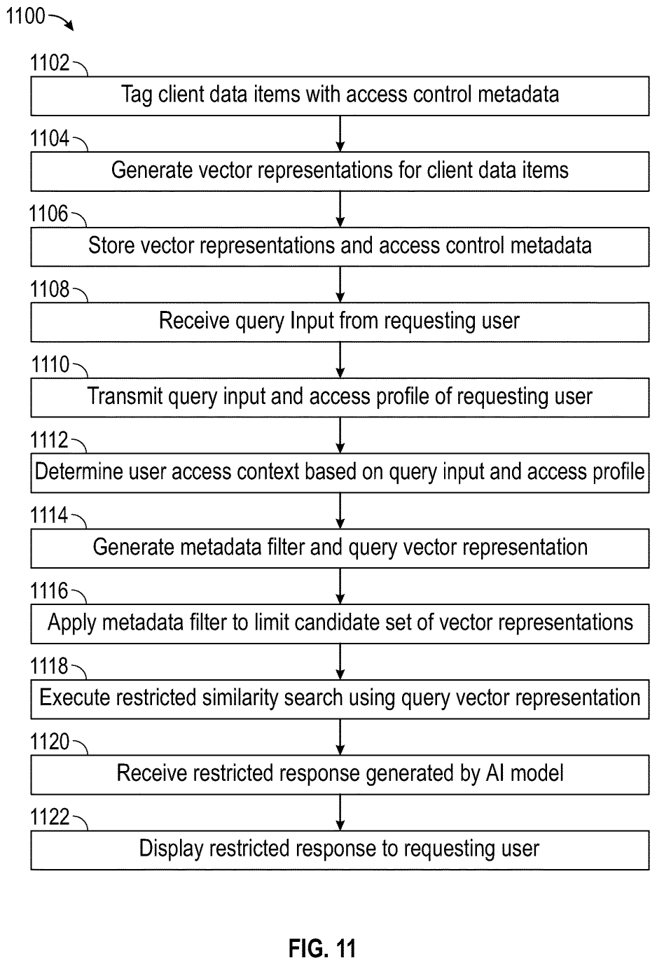

FIG. 11 shows another flowchart illustrating a method 1100 that supports tagging client data for role and intent-based access control in AI models in accordance with various aspects of the present disclosure. The operations of the method 1100 may be implemented by one or more components of a networked computing system as described herein. For example, the operations of the method 1100 may be performed by a data tagging component as described with reference to FIG. 7 through FIG. 9. In some examples, one or more components of a networked computing system may execute a set of instructions to control the functional elements of the component(s) to perform the described functions. Additionally or alternatively, the one or more components of a networked computing system may perform aspects of the described functions using special-purpose hardware.

At 1102, the method 1100 may include tagging client data items with access control metadata for access retrieval control and inference control, the access control metadata indicating an authorized user role and a permitted user intent for each of the client data items. The operations of 1102 may be performed in accordance with examples as disclosed herein. In some examples, aspects of the operations of 1102 may be performed by a metadata tagging component 806 as described with reference to FIG. 8.

At 1104, the method 1100 may include generating, using an embedding model, vector representations for the client data items based on content of the client data items and the access control metadata associated with the client data items. The operations of 1104 may be performed in accordance with examples as disclosed herein. In some examples, aspects of the operations of 1104 may be performed by a vector generation component 808 as described with reference to FIG. 8.

At 1106, the method 1100 may include storing the vector representations and the access control metadata in a searchable data repository. The operations of 1110 may be performed in accordance with examples as disclosed herein. In some examples, aspects of the operations of 1110 may be performed by a data storage component 810 as described with reference to FIG. 8.

At 1108, the method 1100 may include receiving, at a user device, a query input from a requesting user. The operations of 1102 may be performed in accordance with examples as disclosed herein. In some examples, aspects of the operations of 1102 may be performed by a data receiving component 804 as described with reference to FIG. 8.

At 1110, the method 1100 may include transmitting, from the user device to a server, the query input and an access profile of the requesting user, the access profile comprising a role of the requesting user and an intent associated with the query input. The operations of 1104 may be performed in accordance with examples as disclosed herein. In some examples, aspects of the operations of 1104 may be performed by a data receiving component 804 as described with reference to FIG. 8.

At 1112, the method 1100 may include determining, based on the query input and the access profile of the requesting user, a user access context comprising the role of the requesting user and the intent associated with the query input. The operations of 1112 may be performed in accordance with examples as disclosed herein. In some examples, aspects of the operations of 1112 may be performed by a query processing component 812 as described with reference to FIG. 8.

At 1114, the method 1100 may include generating, from the user access context, a metadata filter and a query vector representation. The operations of 1114 may be performed in accordance with examples as disclosed herein. In some examples, aspects of the operations of 1114 may be performed by a metadata filtering component 814 as described with reference to FIG. 8.

At 1116, the method 1100 may include applying the metadata filter to limit, before similarity scoring, a candidate set of the vector representations to vector representations having access control metadata compatible with the user access context. The operations of 1116 may be performed in accordance with examples as disclosed herein. In some examples, aspects of the operations of 1116 may be performed by a metadata filtering component 814 as described with reference to FIG. 8.

At 1118, the method 1100 may include executing a restricted similarity search in the searchable data repository using the query vector representation against the candidate set of the vector representations. The operations of 1118 may be performed in accordance with examples as disclosed herein. In some examples, aspects of the operations of 1118 may be performed by a similarity search component 816 as described with reference to FIG. 8.

At 1120, the method 1100 may include receiving, at the user device from the server, a restricted response generated by an Artificial Intelligence (AI) model, the restricted response being based on policy-compatible client data items retrieved from a searchable data repository. The operations of 1120 may be performed in accordance with examples as disclosed herein. In some examples, aspects of the operations of 1120 may be performed by a response generation component 818 as described with reference to FIG. 8.

At 1122, the method 1100 may include displaying, at the user device, the restricted response to the requesting user. The operations of 1122 may be performed in accordance with examples as disclosed herein. In some examples, aspects of the operations of 1122 may be performed by a response generation component 818 as described with reference to FIG. 8.

It should be noted that the methods described herein describe possible implementations, and that the operations and the steps may be rearranged or otherwise modified, and that other implementations are possible. Furthermore, aspects from two or more of the methods may be combined.

Aspect 1: A method for tagging client data for role and intent-based access control in AI models, comprising: receiving client data items; tagging the client data items with access control metadata for access retrieval control and inference control, the access control metadata indicating an authorized user role and a permitted user intent for each of the client data items; generating, using an embedding model, vector representations for the client data items based on content of the client data items and the access control metadata associated with client data items; storing the vector representations and the access control metadata in a searchable data repository; receiving a query input from a requesting user; determining, based on the query input and an access profile of the requesting user, a user access context comprising a role of the requesting user and an intent associated with the query input; generating, from the user access context, a metadata filter and a query vector representation; applying the metadata filter to limit, before similarity scoring, a candidate set of the vector representations to vector representations having access control metadata compatible with the user access context; executing a restricted similarity search in the searchable data repository using the query vector representation against the candidate set of the vector representations to retrieve policy-compatible client data items; and generating, using the Artificial Intelligence (AI) model and subject to an inference constraint associated with the policy-compatible client data items, a restricted response based on the policy-compatible client data items.

Aspect 1 is a technical solution to a technical problem.

In retrieval-augmented artificial intelligence environments, client data from multiple sources may be transformed into vector representations and stored in a common searchable repository to support similarity-based retrieval and response generation. Conventional access control approaches may govern whether a user can reach an application, interface, or database, but may not provide sufficiently granular control over individual vector representations derived from content having different authorized roles, permitted uses, sensitivity levels, provenance, or temporal validity conditions. As a result, once semantically searchable content is indexed in a shared vector space, a retrieval pipeline may return information outside an authorized scope. Static permission models may also be insufficient where the same user may be permitted to receive one type of response for an analytical purpose but a narrower or different response for another purpose. Additional issues can arise because an artificial intelligence model may disclose restricted information through generated output, including by relying on model memory, combining partially authorized content, or responding to a sequence of prompts that progressively narrows toward protected information.

To address these and other technical issues, the present disclosure in some embodiments describes systems and methods in which client data items, including chunked portions thereof, may be tagged with access control metadata used for both data access retrieval control and inference control. The access control metadata may indicate, for example, one or more authorized user roles, one or more permitted user intents, a sensitivity classification, provenance information, temporal validity conditions, and one or more inference control constraints, and may be incorporated into a policy-conditioned embedding process so that access restrictions are represented both as filterable metadata and in the geometric properties of the resulting vector representations. When a query is received, a user access context may be determined from an access profile of the requesting user and an intent associated with the query, and the user access context may be used to generate a metadata filter and a query vector representation for a restricted similarity search. By limiting the candidate set before similarity scoring, validating retrieved items against applicable inference constraints, and filtering or redacting generated output according to policy-compatible data, the disclosed techniques may provide context-aware control over retrieval and model response generation while reducing unauthorized disclosure across retrieval, inference, and output stages.

Receiving client data items and tagging each item with access control metadata that identifies an authorized user role and a permitted user intent allows the system to establish machine-readable access constraints at ingestion. This arrangement enables later retrieval and response stages to distinguish not only who may access a data item, but also the purpose for which the data item may be used, so access control can be enforced with finer granularity than role-only approaches.

Generating vector representations from both the content of the client data items and the associated access control metadata allows the embeddings to reflect semantic meaning together with policy information. This step enables policy-compatible items to be organized in vector space in a manner that supports controlled semantic retrieval, including separation of semantically similar content when the associated access conditions differ.

Storing the vector representations together with the access control metadata in a searchable data repository allows similarity-based retrieval and metadata-based restriction to operate on the same stored records. This arrangement enables efficient pre-filtering of candidate vectors using indexed metadata fields before search processing proceeds, while preserving the association between each vector and its governing access conditions.

Receiving a query input and determining, from the query input and the requesting user's access profile, a user access context that includes the user's role and an associated intent allows query-time control to depend on both user identity and request purpose. This step enables downstream retrieval processing to be aligned with the specific context of the request, including use of a restrictive intent classification when the query is ambiguous.

Generating, from the user access context, a metadata filter and a query vector representation allows the system to coordinate candidate-set restriction with policy-aware query encoding. This arrangement enables the search input and the search boundaries to be derived from the same access determination, so the retrieval process can remain aligned with the user's authorized scope instead of relying on a purely semantic query alone.

Applying the metadata filter before similarity scoring to limit the candidate set to vector representations having compatible access control metadata allows unauthorized vectors to be excluded before distance computations are performed. This step enables hard restriction of the search space at the repository level, so non-compatible entries are not scored, ranked, or selected during the similarity search.

Executing a restricted similarity search in the searchable data repository using the query vector representation against the filtered candidate set allows retrieval to focus on items that are both semantically relevant and policy-compatible. This arrangement enables the system to return client data items from within the authorized search space while reducing retrieval of content that falls outside the user access context.

Generating, with the AI model and subject to an inference constraint associated with the policy-compatible client data items, a restricted response based on those client data items allows output generation to remain governed by the same policy framework that controlled retrieval. This step enables the response to be limited through measures such as aggregation, omission, redaction, or prevention of impermissible cross-item inference, thereby reducing unauthorized disclosure during AI-based response generation.

Aspect 2: The method of aspect 1, further comprising assigning, during the tagging, a sensitivity classification to the client data items, the sensitivity classification being selected from a hierarchy including public, internal, confidential, and restricted, and storing the sensitivity classification as part of the access control metadata in the searchable data repository.

Aspect 3: The method of any of aspects 1 through 2, further comprising segmenting the client data items into chunks prior to generating the vector representations, wherein each chunk inherits document-level access control metadata and is further tagged with chunk-specific metadata based on content analysis of the chunk.

Aspect 4: The method of any of aspects 1 through 3, further comprising constructing a structured policy prefix from the access control metadata associated with the client data items, prepending the structured policy prefix to text of the client data items, and embedding the policy-augmented text to generate the vector representations.

Aspect 5: The method of any of aspects 1 through 4, further comprising validating, after storing the vector representations, that each stored vector representation includes a complete and consistent set of access control metadata, and quarantining any vector representation missing required metadata for administrative review.

Aspect 6: The method of any of aspects 1 through 5, further comprising applying an output filter to the restricted response generated by the AI model, the output filter being configured to redact restricted content derived from parametric memory of the AI model that is not included in the retrieved policy-compatible client data items.

Aspect 7: The method of any of aspects 1 through 6, wherein tagging the client data items comprises executing an automated classifier during receipt of the client data items to detect sensitive content and assign a sensitivity classification included in the access control metadata.

Aspect 8: The method of any of aspects 1 through 7, wherein storing the vector representations and the access control metadata in the searchable data repository comprises storing the access control metadata as filterable metadata fields alongside respective ones of the vector representations.

Aspect 9: The method of any of aspects 1 through 8, wherein determining the user access context comprises applying an intent classification model to the query input to identify the intent associated with the query input.

Aspect 10: The method of any of aspects 1 through 9, wherein determining the intent associated with the query input further comprises updating an output of the intent classification model based on prior prompts received during a session of the requesting user.

Aspect 11: The method of any of aspects 1 through 10, wherein the user access context comprises a plurality of roles associated with the requesting user, and the metadata filter is configured to admit a vector representation when the access control metadata of the vector representation is compatible with any one of the plurality of roles.

Aspect 12: The method of any of aspects 1 through 11, wherein the metadata filter includes a temporal validity condition requiring access control metadata of an admitted vector representation to indicate current validity at a time of the restricted similarity search.

Aspect 13: The method of any of aspects 1 through 12, wherein executing the restricted similarity search comprises performing an approximate neighbor search over the candidate set of the vector representations.

Aspect 14: The method of any of aspects 1 through 13, further comprising, after executing the restricted similarity search, evaluating retrieved client data items against one or more inference control flags and removing a retrieved client data item that violates the one or more inference control flags.

Aspect 15: The method of any of aspects 1 through 14, wherein the one or more inference control flags comprise an aggregation-only flag and a minimum k-anonymity threshold for an aggregate response.

Aspect 16: The method of any of aspects 1 through 15, wherein the one or more inference control flags comprise a cross-reference restriction that prevents combining a first retrieved client data item from a first sensitivity domain with a second retrieved client data item from a second sensitivity domain in the restricted response.

Aspect 17: The method of any of aspects 1 through 16, wherein generating the restricted response comprises selecting, from a plurality of Artificial Intelligence (AI) models, the Artificial Intelligence (AI) model based on an uppermost sensitivity classification among the policy-compatible client data items retrieved by the restricted similarity search.

Aspect 18: The method of any of aspects 1 through 17, wherein the query input from the requesting user is a prompt.

Aspect 19: The method of any of aspects 1 through 18, wherein the tagging further comprises assigning data provenance metadata to the client data items, the data provenance metadata including a source identifier, a document identifier, and an ingestion timestamp.

Aspect 20: The method of any of aspects 1 through 19, wherein the metadata filter is further configured to exclude vector representations associated with client data items having expired temporal validity tags.

Aspect 21: The method of any of aspects 1 through 20, wherein the restricted response is generated by applying an inference constraint that limits the response to aggregate statistics derived from the policy-compatible client data items.

Aspect 22: The method of any of aspects 1 through 21, wherein the tagging further comprises assigning intent-scope indicators to the client data items, the intent-scope indicators specifying permitted intents for accessing the client data items.

Aspect 23: The method of any of aspects 1 through 22, wherein the restricted similarity search further comprises applying a differential similarity scoring mechanism to reduce the likelihood of retrieving vector representations near an authorization boundary.

Aspect 24: The method of any of aspects 1 through 23, wherein the tagging further comprises assigning inference control flags to the client data items, the inference control flags specifying whether the client data items may be directly cited in the restricted response.

Aspect 25: The method of any of aspects 1 through 24, wherein the restricted response is generated by applying an output filter that replaces restricted content with redaction markers based on the access control metadata of the retrieved client data items.

Aspect 26: A system for tagging client data for role and intent-based access control in AI models, comprising a processor; memory coupled with the processor; and instructions stored in the memory and executable by the processor to cause the system to perform a method of any of aspects 1 through 25.

Aspect 27: A system for tagging client data for role and intent-based access control in AI models, comprising at least one means for performing a method of any of aspects 1 through 25.

Aspect 28: A non-transitory computer-readable medium storing code for tagging client data for role and intent-based access control in AI models, the code comprising instructions executable by a processor to perform a method of any of aspects 1 through 25.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media include both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data access retrieval control and inference control of an Artificial Intelligence (AI) model, comprising:
receiving client data items;
tagging the client data items with access control metadata for access retrieval control and inference control, the access control metadata indicating an authorized user role and a permitted user intent for each of the client data items;
generating, using an embedding model, vector representations for the client data items based on content of the client data items and the access control metadata associated with client data items;
storing the vector representations and the access control metadata in a searchable data repository;
receiving a query input from a requesting user;
determining, based on the query input and an access profile of the requesting user, a user access context comprising a role of the requesting user and an intent associated with the query input;
generating, from the user access context, a metadata filter and a query vector representation;
applying the metadata filter to limit, before similarity scoring, a candidate set of the vector representations to vector representations having access control metadata compatible with the user access context;
executing a restricted similarity search in the searchable data repository using the query vector representation against the candidate set of the vector representations to retrieve policy-compatible client data items; and
generating, using the Artificial Intelligence (AI) model and subject to an inference constraint associated with the policy-compatible client data items, a restricted response based on the policy-compatible client data items.

2. The method of claim 1, further comprising assigning, during the tagging, a sensitivity classification to the client data items, the sensitivity classification being selected from a hierarchy including public, internal, confidential, and restricted, and storing the sensitivity classification as part of the access control metadata in the searchable data repository.

3. The method of claim 1, further comprising segmenting the client data items into chunks prior to generating the vector representations, wherein each chunk inherits document-level access control metadata and is further tagged with chunk-specific metadata based on content analysis of the chunk.

4. The method of claim 1, further comprising constructing a structured policy prefix from the access control metadata associated with the client data items, prepending the structured policy prefix to text of the client data items, and embedding the policy-augmented text to generate the vector representations.

5. The method of claim 1, further comprising validating, after storing the vector representations, that each stored vector representation includes a complete and consistent set of access control metadata, and quarantining any vector representation missing required metadata for administrative review.

6. The method of claim 1, further comprising applying an output filter to the restricted response generated by the Artificial Intelligence (AI) model, the output filter being configured to redact restricted content derived from parametric memory of the Artificial Intelligence (AI) model that is not included in the retrieved policy-compatible client data items.

7. The method of claim 1, wherein tagging the client data items comprises executing an automated classifier during receipt of the client data items to detect sensitive content and assign a sensitivity classification included in the access control metadata.

8. The method of claim 1, wherein storing the vector representations and the access control metadata in the searchable data repository comprises storing the access control metadata as filterable metadata fields alongside respective ones of the vector representations.

9. The method of claim 1, wherein determining the user access context comprises applying an intent classification model to the query input to identify the intent associated with the query input.

10. The method of claim 9, wherein determining the intent associated with the query input further comprises updating an output of the intent classification model based on prior prompts received during a session of the requesting user.

11. The method of claim 1, wherein the user access context comprises a plurality of roles associated with the requesting user, and the metadata filter is configured to admit a vector representation when the access control metadata of the vector representation is compatible with any one of the plurality of roles.

12. The method of claim 1, wherein the metadata filter includes a temporal validity condition requiring access control metadata of an admitted vector representation to indicate current validity at a time of the restricted similarity search.

13. The method of claim 1, wherein executing the restricted similarity search comprises performing an approximate neighbor search over the candidate set of the vector representations.

14. The method of claim 1, further comprising, after executing the restricted similarity search, evaluating retrieved client data items against one or more inference control flags and removing a retrieved client data item that violates the one or more inference control flags.

15. The method of claim 14, wherein the one or more inference control flags comprise an aggregation-only flag and a minimum k-anonymity threshold for an aggregate response.

16. The method of claim 14, wherein the one or more inference control flags comprise a cross-reference restriction that prevents combining a first retrieved client data item from a first sensitivity domain with a second retrieved client data item from a second sensitivity domain in the restricted response.

17. The method of claim 1, wherein generating the restricted response comprises selecting, from a plurality of Artificial Intelligence (AI) models, the Artificial Intelligence (AI) model based on an uppermost sensitivity classification among the policy-compatible client data items retrieved by the restricted similarity search.

18. The method of claim 1, wherein the query input from the requesting user is a prompt.

19. The method of claim 1, wherein the tagging further comprises assigning data provenance metadata to the client data items, the data provenance metadata including a source identifier, a document identifier, and an ingestion timestamp.

20. The method of claim 1, wherein the metadata filter is further configured to exclude vector representations associated with client data items having expired temporal validity tags.

21. The method of claim 1, wherein the restricted response is generated by applying an inference constraint that limits the response to aggregate statistics derived from the policy-compatible client data items.

22. The method of claim 1, wherein the tagging further comprises assigning intent-scope indicators to the client data items, the intent-scope indicators specifying permitted intents for accessing the client data items.

23. The method of claim 1, wherein the restricted similarity search further comprises applying a differential similarity scoring mechanism to reduce a likelihood of retrieving vector representations near an authorization boundary.

24. The method of claim 1, wherein the tagging further comprises assigning inference control flags to the client data items, the inference control flags specifying whether the client data items may be directly cited in the restricted response.

25. The method of claim 1, wherein the restricted response is generated by applying an output filter that replaces restricted content with redaction markers based on the access control metadata of the retrieved client data items.

26. A system configured for data access retrieval control and inference control of an Artificial Intelligence (AI) model, comprising:
a processor;
memory coupled with the processor; and
instructions stored in the memory and executable by the processor to cause the system to:
receive client data items;
tag the client data items with access control metadata for access retrieval control and inference control, the access control metadata indicating an authorized user role and a permitted user intent for each of the client data items;
generate, using an embedding model, vector representations for the client data items based on content of the client data items and the access control metadata associated with the client data items;
store the vector representations and the access control metadata in a searchable data repository;
receive a query input from a requesting user;
determine, based on the query input and an access profile of the requesting user, a user access context comprising a role of the requesting user and an intent associated with the query input;
generate, from the user access context, a metadata filter and a query vector representation;
apply the metadata filter to limit, before similarity scoring, a candidate set of the vector representations to vector representations having access control metadata compatible with the user access context;
execute a restricted similarity search in the searchable data repository using the query vector representation against the candidate set of the vector representations to retrieve policy-compatible client data items; and
generate, using the Artificial Intelligence (AI) model and subject to an inference constraint associated with the policy-compatible client data items, a restricted response based on the policy-compatible client data items.
